(19) United States
(12) Patent Application Publication
(10) Pub. No.: US 2013/0254710 A1
(43) Pub. Date: Sep. 26, 2013

(54) STACKS FOR CONTENT ORGANIZATION

(71) Applicants: Edward Thomas Banti, Seattle, WA (US); Kartik S. Murthy, Seattle, WA (US); Elroy J. Dyksen, Mountain View, CA (US); Jeffrey Sherman, Duvall, WA (US); Kristian Andaker, Redmond, WA (US); Selvaraj Nalliah, Redmond, WA (US); Bethany Kessen Doan, Austin, TX (US)

(72) Inventors: Edward Thomas Banti, Seattle, WA (US); Kartik S. Murthy, Seattle, WA (US); Elroy J. Dyksen, Mountain View, CA (US); Jeffrey Sherman, Duvall, WA (US); Kristian Andaker, Redmond, WA (US); Selvaraj Nalliah, Redmond, WA (US); Bethany Kessen Doan, Austin, TX (US)

(73) Assignee: MICROSOFT CORPORATION, Redmond, WA (US)

(21) Appl. No.: 13/427,299

(22) Filed: Mar. 22, 2012

(51) Int. Cl. G06F 3/048

(52) U.S. Cl. 715/810

(57) ABSTRACT

Stacks that associate different electronic content are created using tags that are associated with electronic content. Stacks may be personal, organizational and/or shared. A tag may be associated with different types of electronic content (e.g. documents, people, contacts, meetings, emails, . . . ) that may be stored in different locations. The tag acts as an identifier that travels with the content as the electronic content is used. Content may be automatically/manually tagged. As the tagged content is used, the different applications that interact with the content (e.g. a messaging application, a content application) can use the tag to perform different actions. Changes to content with a tag may be aggregated such that users looking at the “consolidated” view can see all changes made to content or activity related to that content.

### BACKGROUND

Electronic folders are used to store various electronic content. For example, a user may create folders to store word-processing documents, folders to store mail, folders to store pictures, and the like. Locating this stored content can be difficult. For example, many times a user performs a search to locate content that they previously stored because they don't remember the location of the content.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Stacks that associate content together are created using tags that are associated with electronic content. Stacks may be personal, system and/or shared. A tag may be associated with different types of electronic content (e.g. documents, people, contacts, meetings, emails, . . . ) that may be stored in different locations. The tag acts as an identifier that travels with the content as the electronic content is used. Content may be automatically/manually tagged. For example, content may be automatically tagged based on keywords or some other characteristics relating to the content. As the tagged content is used, the different applications that interact with the content (e.g. a messaging application, a content application) can use the tag to perform different actions. For example, a user may view a stack to see a single view of the content that is associated with a tag across different systems (e.g. consolidated views across messaging applications, a user's desktop, productivity applications, and the like). Changes to content with a tag may be aggregated such that users looking at the “consolidated” view can see all changes made to content or activity related to that content.

### BRIEF DESCRIPTION OF THE DRAWINGS

FIG. 1 illustrates an exemplary system for interacting with tagged electronic content;

FIG. 2 illustrates interacting with a stack;

FIG. 3 shows a process for creating a stack;

FIGS. 4 and 5 illustrate personal stacks and organization stacks that are associated with a messaging application;

FIG. 6 illustrates top-down stack creation from an organization;

FIG. 7 shows creating a stack starting in a messaging application;

FIG. 8 shows creating a stack starting in a collaboration application;

FIG. 9 illustrates showing stacks within a messaging application;

FIG. 10 shows a display of two stacks including a project stack and a personal stack;

FIG. 11 illustrates an overview page for a stack;

FIG. 12 shows a message that includes a display of an associated stack;

FIG. 13 illustrates a display of activity and people regarding a project;

FIG. 14 shows a display of documents within a project;

FIG. 15 shows an exemplary display of a stack for a messaging application;

FIG. 16 shows a display of a stack filtered by people;

FIG. 17 shows stacks for documents;

FIGS. 18-24 illustrate naming a stack;

FIGS. 25-30 show linking a stack to an application and a distribution list (DL);

FIGS. 30-32 illustrate manually adding items to a stack;

FIG. 33 illustrates a user entering a name for a stack;

FIG. 34 illustrates stack “Project Contoso” after being created;

FIG. 35 illustrates sharing stacks;

FIGS. 36-42 illustrate creating stacks ad-hoc;

FIG. 43 illustrates display that shows a user creating a message that is associated with a stack;

FIG. 44 illustrates display that shows a user addressing a message to a person that is not associated with the stack and is outside of the organization; and

FIGS. 45-47 and the associated descriptions provide a discussion of a variety of operating environments in which embodiments of the invention may be practiced.

### DETAILED DESCRIPTION

Referring now to the drawings, in which like numerals represent like elements, various embodiments will be described.

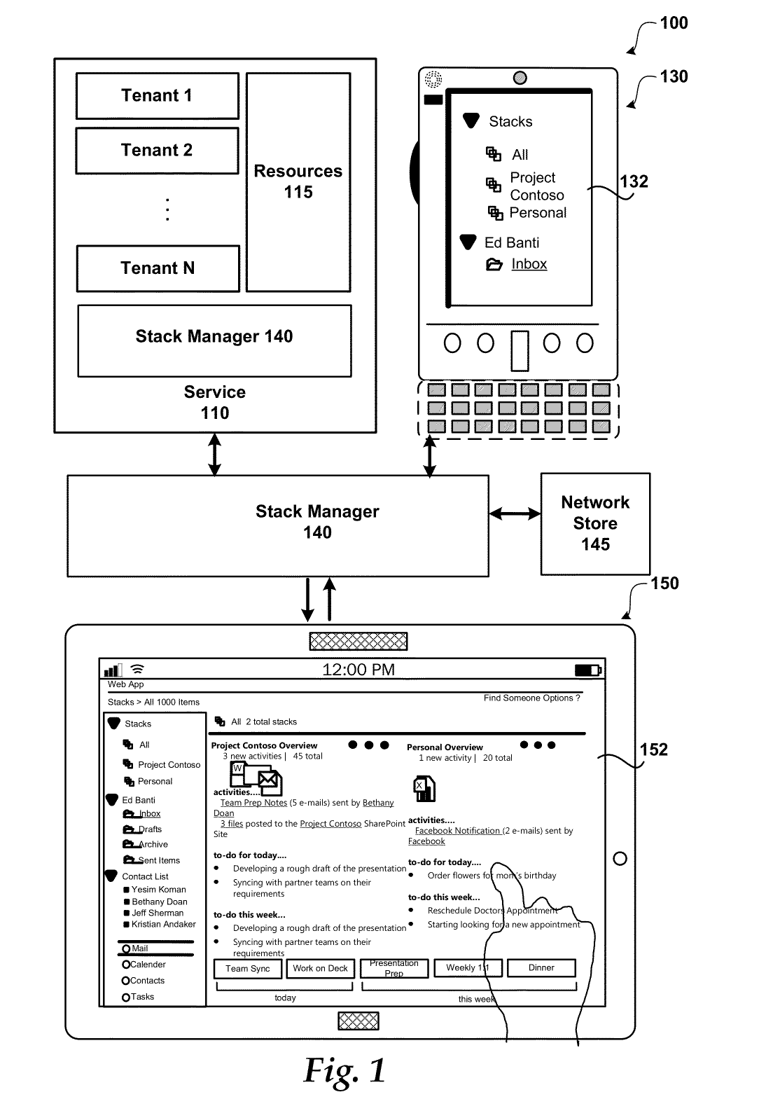

FIG. 1 illustrates an exemplary system for interacting with tagged electronic content. As illustrated, system 100 includes service 110, stack manager 140, store 145, touch screen input device/display 150 (e.g. slate) and smart phone 130.

Service 110 is a cloud based and/or enterprise based service that may be configured to provide a service, such as a productivity services (e.g. MICROSOFT OFFICE 365 or some other cloud based/online service that is used to interact with items (e.g. spreadsheets, documents, charts, and other electronic content). Functionality of one or more of the services/applications provided by service 110 may also be configured as a client based application. For example, a client device may include a messaging/content application that performs operations with/without functionality provided by service 110. Although system 100 shows a productivity service, other services/applications may be configured to interact with tagged content. As illustrated, service 110 is a multi-tenant service that provides resources 115 and services to any number of tenants (e.g. Tenants 1-N). According to an embodiment, multi-tenant service 110 is a cloud based service that provides resources/services 115 to tenants subscribed to the service and maintains each tenant's data separately and protected from other tenant data.

System 100 as illustrated comprises a touch screen input device/display 150 (e.g. a slate/tablet device) and smart phone 130 that detects when a touch input has been received (e.g. a finger touching or nearly touching the touch screen). Any type of touch screen may be utilized that detects a user's touch input. For example, the touch screen may include one or more layers of capacitive material that detects the touch input. Other sensors may be used in addition to or in place of the capacitive material. For example, Infrared (IR) sensors may be used. According to an embodiment, the touch screen is configured to detect objects that in contact with or above a touchable surface. Although the term “above” is used in this description, it should be understood that the orientation of the touch panel system is irrelevant. The term “above” is intended to be applicable to all such orientations. The touch screen may be configured to determine locations of where touch input is received (e.g. a starting point, intermediate points and an ending point). Actual contact between the touchable surface and the object may be detected by any suitable means, including, for example, by a vibration sensor or microphone coupled to the touch panel. A non-exhaustive list of examples for sensors to detect contact includes pressure-based mechanisms, micro-machined accelerometers, piezoelectric devices, capacitive sensors, resistive sensors, inductive sensors, laser vibrometers, and LED vibrometers.

As illustrated, touch screen input device/display 150 and smart phone 130 shows an exemplary display 152/132 illustrating electronic content arranged in stacks. Stacks are directed at providing a better way of organizing information that aligns with how people work. Stacks may be configured to show a single view for messages (e.g. e-mail, SMS), documents, meetings, and other shared content related to current or past activities across different applications/services such as a messaging service and a content service.

Electronic content may be stored on a device (e.g. smart phone 130, slate 150 and/or at some other location (e.g. network store 145). Smart phone 130 shows a display 132 of a list that shows a list of stacks that may be selected for viewing/interacting with. Slate 150 shows a list of stacks and an overview of two of the stacks within the list.

Stack manager 140 is configured to perform operations relating to interacting with and creating stacks. Stacks are created using tags that are associated with electronic content. Stacks may be personal, system/organizational and/or shared. A tag may be associated with different types of electronic content (e.g. documents, people, contacts, meetings, emails, . . . ) that may be stored in different locations. The tag acts as an identifier that travels with the content as the electronic content is used. Content may be automatically/manually tagged. For example, content may be automatically tagged based on keywords or some other characteristics relating to the content. As the tagged content is used, the different applications that interact with the content (e.g. a messaging application, a content application) can use the tag to perform different actions. For example, a user may view the stack to see a single view of the content that is associated with a tag across different systems (e.g. consolidated views across messaging applications, a user's desktop, productivity applications, and the like). Changes to content with a tag may be aggregated such that users looking at the “consolidated” view can see all changes made to content or activity related to that content may be selected in response to touch input and/or other input.

Stacks may be used by a user to see activities and information that is not constrained to a single application/service. For example, many projects include activities and information that is spread across multiple applications (e.g. information may be spread across a messaging service and a content service). Without the use of a stack to associate different electronic content, a user has to switch applications and context in order to view the different content. The use of stacks also assists in maintaining a connection to the team's work within a project without causing the user to have to perform an extensive amount of communication and collaboration in order to interact with/view the content.

The following examples are for explanatory purposes relating to the use of stacks and are not intended to be limiting.

Suppose that John is an office worker who spends a lot of time on the phone, in meetings, or working on e-mail. He tries to keep his notes, e-mails, appointments, and to-do list organized, but it's a constant challenge considering how busy he is at work and outside of work with personal commitments. Throughout the day he gets new information that he needs to remember and in many cases use when doing his work. When John is in a meeting, on the phone, or participating in a random hallway conversation, one or more stacks are used to quickly capture the information that comes out of those conversations, at that moment. The information within a stack is accessible and easy to organize. Whenever John receives an e-mail or some other piece of communication that has something notable, this information may be saved in the related stack(s). Using stack(s) to capture and remember pieces of electronic content, John is less concerned about making a mistake and happily more focused on getting his work done. By having all the information easily accessible within a single stack or multiple stacks, John is more productive and is known for producing higher quality work that is more thorough and detailed than he could've produced otherwise.

As another example, suppose that Bob runs a small home consulting business and is also the father of two kids who play soccer. Bob tends to receive a wide assortment of messages each day. One message might correspond to a project he is working on for a client while the next message may be regarding the organization of his kids' soccer league. Due to his variety of responsibilities, Bob's inbox is constantly filled with a wide range of content dealing with his multiple responsibilities.

In order to organize his day, Bob tries to set aside time slots for when he will work on each of his consulting projects, as well as when he will focus on his children's activities. During these discrete intervals, Bob would like to see the subset of content that is relevant to the current task or project he is working on. Using different stacks for the different projects/activities allows Bob to quickly see the related content.

As yet another example, Sarah leads the marketing team for a medium sized business, that manufactures and sells sporting goods. On any given day, Sarah spends most of her time in meetings. When she manages to find a break, it is vital that she can quickly understand how her team is progressing on their deliverables and what items require her attention. Sarah needs to be able to find the right people on her team to talk with about project issues, discover related work and deliverables her team has produced, and be able to understand the status and dependencies of the project that is currently her focus. Since stacks may be used to store a variety of different content (e.g. messages, documents, events, people, notes, . . . ), Sarah can use stacks to quickly view the related electronic content.

As another example, Kate regularly gets promising leads on new clients. Working with a prospect to assemble a successful consulting proposal involves exchanging background information, gathering requirements, and finally submitting a formal proposal. All of this information may be associated with a stack. Once Kate lands a new client she must quickly assemble a team and bring everyone up to speed with all the relevant background material. Kate can't be guaranteed that she will always have the same PR specialists working on each of her accounts, nor can she assume they are only working on her accounts. By sharing one or more stacks, Kate may share the pertinent material that went into developing the winning proposal, loop in all the right team members on her side and the client's side, and quickly get everyone up-to-speed, in order to kick off the new relationship and have it running smoothly from the start.

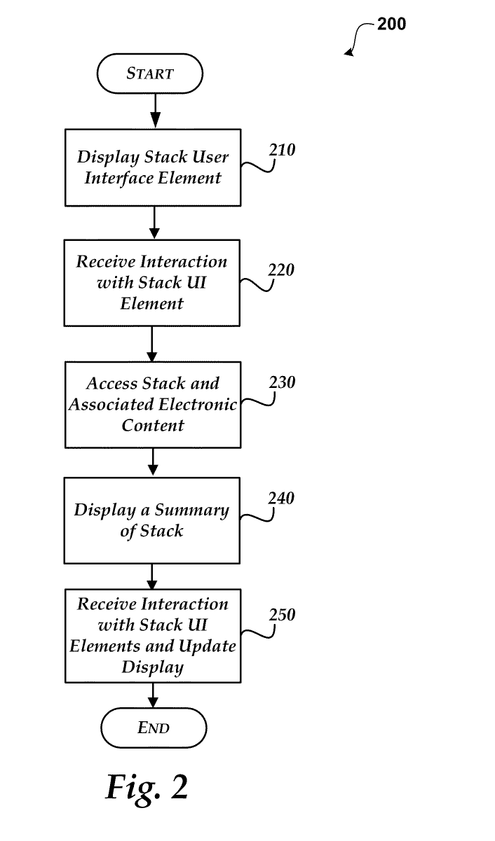

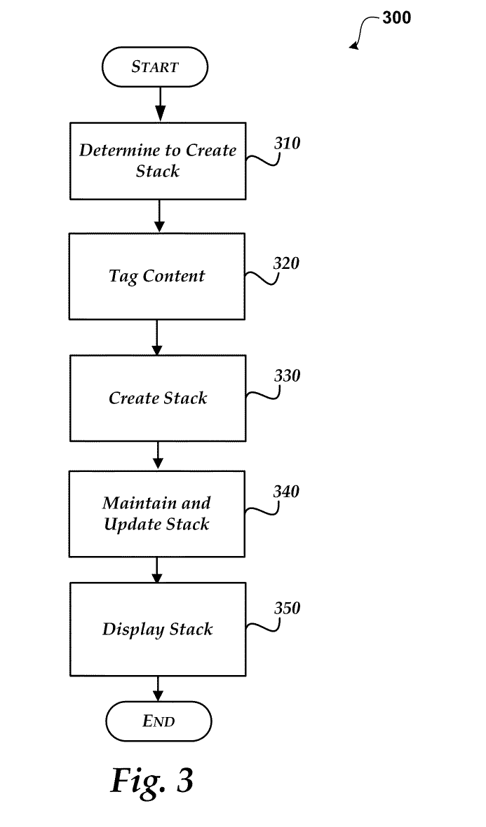

FIGS. 2-3 show an illustrative process for creating and interacting with stacks.

When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

FIG. 2 illustrates interacting with a stack.

After a start operation, the process 200 flows to operation 210, where a stack user interface (UI) element is displayed. According to an embodiment, the stack UI element is a selectable option that is displayed within a messaging application along with other messaging content. The stack UI element may be used to select one or more stacks. Different stack UI elements may be used to change a view of a stack and/or select different stacks with which to interact.

Moving to operation 220, an interaction with the stack UI element is received. For example, a user may select the option using touch input and/or hardware input.

Flowing to operation 230, the stack that is associated with the selected stack UI element is accessed. The selection may be associated with one or more stacks. For example, a user may select all/portion of the stacks. As discussed and shown in more detail below, the electronic content comprises different electronic content across different applications. For example, the content may come from a messaging application, a content application, a project application, a calendar application, and the like.

Transitioning to operation 240, a summary of the selected stack(s) is initially displayed. According to an embodiment, the summary includes a number of new activities, a section for: electronic messages; documents; people; events; and notes. According to an embodiment, a default view of the stack may be configured.

Moving to operation 250, different interactions with the stack may be received and as a result of the interaction, the view of the stack changes. For example, a user may select to show a more detailed view of: the electronic messages associated with the stack; documents associated with the stack; people associated with the stack; events associated with the stack; and notes associated with the stack.

The process then moves to an end operation and returns to processing other actions.

FIG. 3 shows a process for creating a stack.

After a start operation, the process 300 flows to operation 310, where a determination is made to create a stack. A stack may be created automatically/manually. For example, a user may select different content to include within a stack and/or different content may be selected automatically (e.g. content associated with a project, a subject, a conversation, and the like). A stack may be a personal stack and/or a system stack.

Moving to operation 320, the initial content to include within a stack is tagged. For example, the content may be tagged with an identifier, such as one or more of: a name of a project, user, time, date, and the like. Different stacks may include the same content. For example, an system stack may include electronic content that is also included in one or more personal stacks and/or other system stacks.

Flowing to operation 330, the stack is created. The content of the stack may be stored in different locations. For example, the content may be stored according to: a location associated with an application that creates/receives the content; a preference of a user; and the like.

Transitioning to operation 340, the stack is maintained and updated as new content is received that is related to the stack and/or removed from the stack. For example, new messages may be received, people may be associated with the stack, events may be added/removed, notes and documents may be added/removed, and the like.

Moving to operation 350, the stack may be displayed. For example, the stack may be displayed within one or more different applications user interfaces (See FIGURES below for exemplary displays).

The process then moves to an end operation and returns to processing other actions.

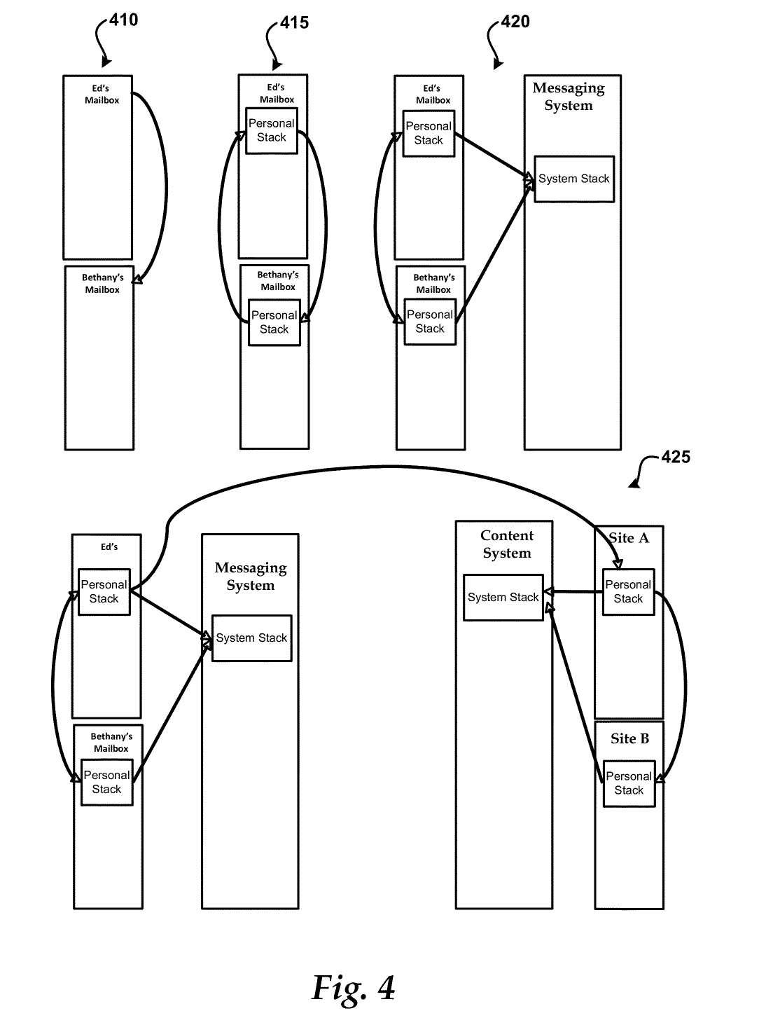

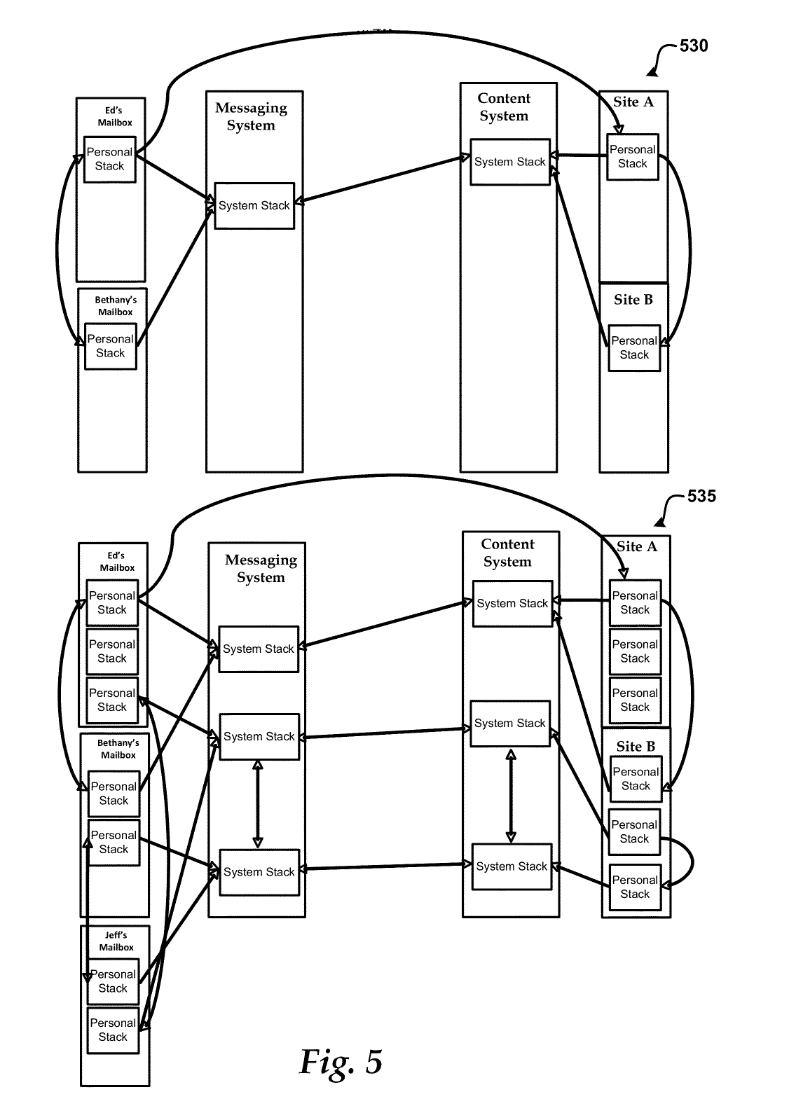

FIGS. 4 and 5 illustrate personal stacks and organization stacks that are associated with a messaging system (e.g. MICROSOFT EXCHANGE), and a content system (e.g. MICROSOFT SHAREPOINT). Stacks may grow organically from end-user interaction and/or organizationally from a business owner/content steward. As discussed herein, stacks are clusters of related electronic content similarly tagged that may be stored in different content stores.

Display 410 shows a user (Ed) starting a conversation with another user (Bethany). Initially in the example illustrated in FIG. 4, there are not any stacks.

Display 415 shows that as the users Ed and Bethany send messages back and forth, a personal stack is created and automatically updated throughout the conversation. As illustrated, a stack is created in each of the user's mailbox. The personal stack may be stored in other locations (e.g. on a device, network store, and the like).

Display 420 illustrates connecting personal stacks with an system-wide stack. A system stack may be created to associate similarly tagged content within an organization/system. For example, in this example, the stacks are created at a level of a messaging application.

Display 425 shows coupling stacks. As documents pass from a user's e-mail to the content system (e.g. SharePoint), the stack identifiers persist which the content service recognizes as an system-wide stack.

Turning now to FIG. 5, display 530 shows two different applications (e.g. a content application and a messaging application) identifying that each of the system stacks are the same entity and keeping the two stacks synchronized and connected. As policy is applied to a stack in the messaging system or the content system, that policy is applied consistently to content within the stack across mailboxes and sites (e.g. SHAREPOINT sites).

Display 535 illustrates that over time this process repeats for as numerous stacks are created, merge, and complete.

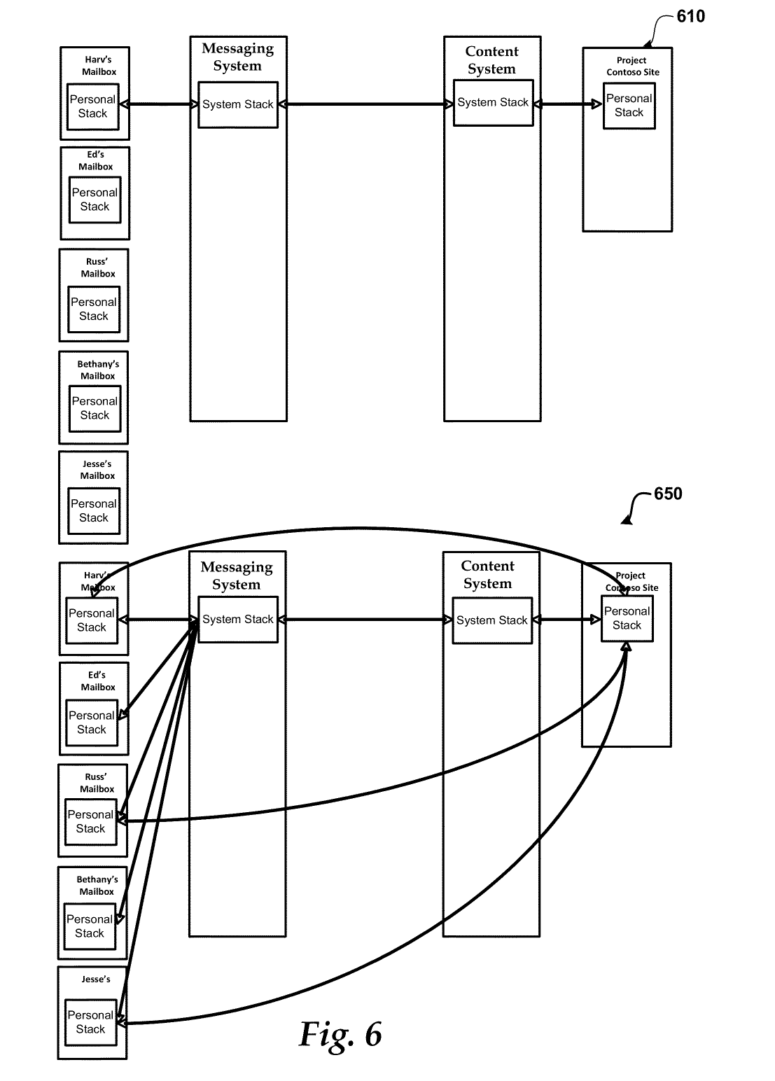

FIG. 6 illustrates top-down stack creation from an organization.

Display 610 shows a user, Harv creating a personal stack for Project Contoso in his mailbox and selects that a corresponding content site (e.g. a SHAREPOINT site) is created for the project. He also specifies the people involved in the project (e.g. Ed, Russ, Bethany, Jesse).

The stack creation process automatically provisions an system-wide stack in the user's messaging application/service, personal stacks for the people involved in Project Contoso, and a corresponding system-wide stack and content site in the content system.

The electronic content (e.g. e-mail and documents) associated with the stack are linked (650) to the proper system-wide stack without disambiguation required.

As documents pass from the messaging application to the content application and person to person, the stack identifier is persisted across applications and their boundaries. As policy is applied to a stack in the messaging application and/or the content application that policy is applied consistently to content within the stack across mailboxes and content sites.

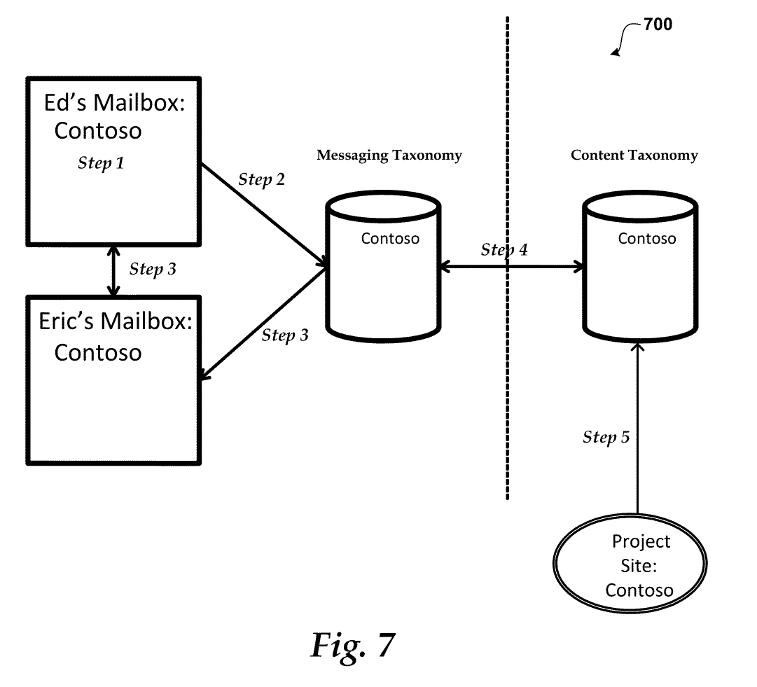

FIG. 7 shows creating a stack starting in a messaging application.

At step 1, the user “Ed” creates a stack in his mailbox named “Contoso” related to a project he is starting up. During creation he indicates that the stack is shareable.

At step 2, the stack Contoso is added to the messaging application's Taxonomy Service.

Moving to step 3, Ed and Eric send each other e-mail related to Project Contoso. At some point Eric decides to organize his e-mail into a stack. He starts to type “Con.” and the name “Contoso” is suggested to him. He accepts the suggestion and creates a stack named “Contoso.”

At step 4, the applications synchronize their taxonomies and Contoso is created in the content application taxonomy.

At step 5, Eric goes to the content application to create a project site for Project Contoso. As he types the name of the project, the name Contoso is suggested to him. He accepts the suggestion.

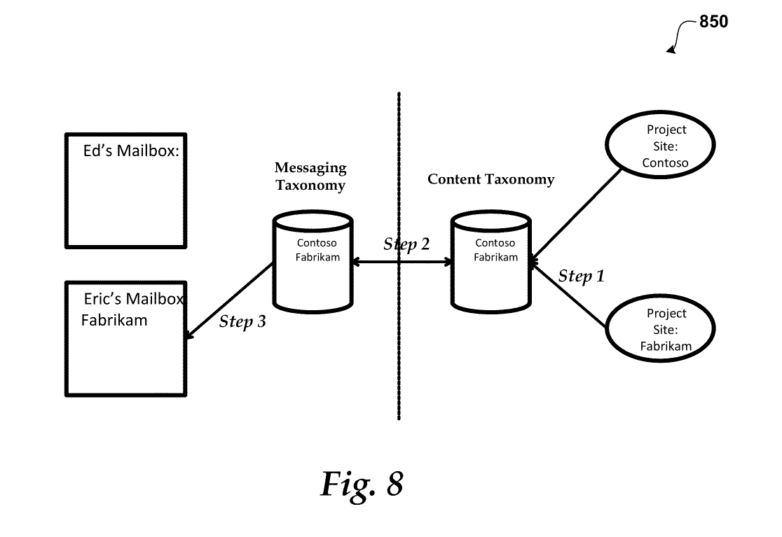

FIG. 8 shows creating a stack 850 starting in a collaboration application.

At step 1, Eric uses the content application and creates a project site for Fabrikam. This adds Fabrikam to the content application's taxonomy. At this point, the taxonomy includes the project site Contoso and Fabrikam.

At step 2, the messaging application and the content application sync their taxonomies. Fabrikam is added from the content application's taxonomy into the messaging application's taxonomy.

At step 3, when Eric goes to create a stack for Fabrikam, it's auto-suggested as the stack name. According to another embodiment, the user is automatically invited to create a stack as soon as the content site is provisioned.

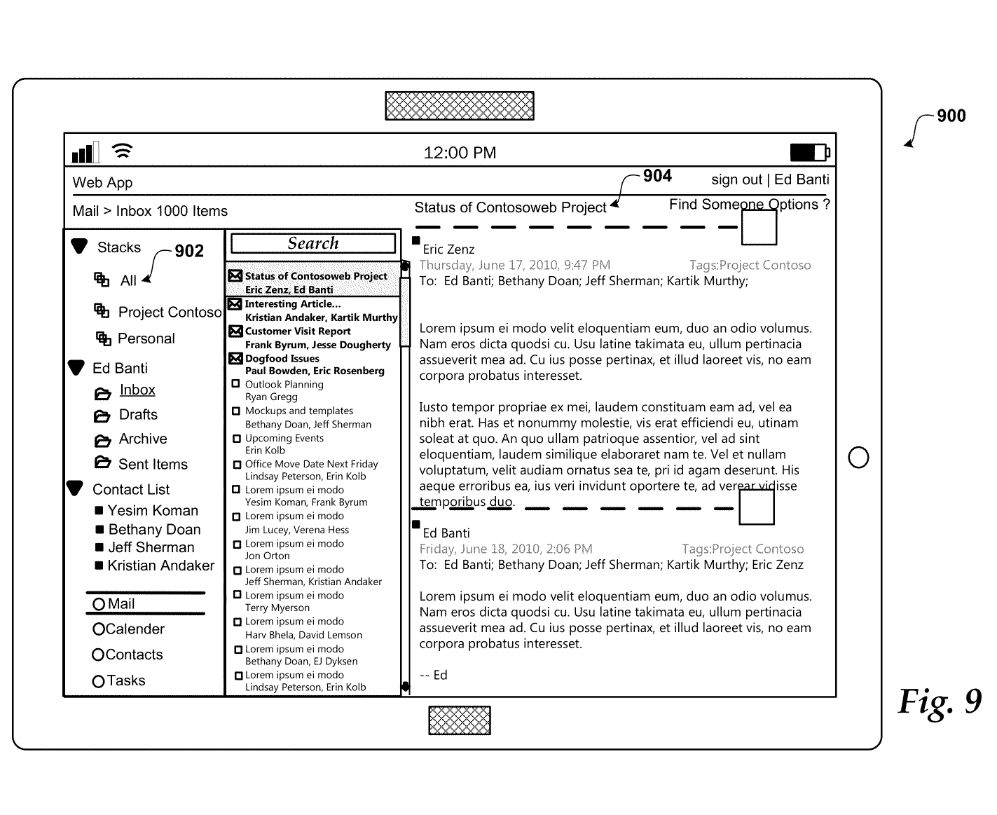

FIG. 9 illustrates showing stacks within a messaging application.

As illustrated, display 900 shows a web based access display to a messaging application that includes a display of available stacks 902 and a preview area 904. In the current example, the stacks are shown as a top-level navigation element. According to an embodiment, the display of the stacks is illustrated similarly to a folder view thereby helping to reduce confusion for users used to interacting with folders. Stacks may be created by a user and/or automatically created.

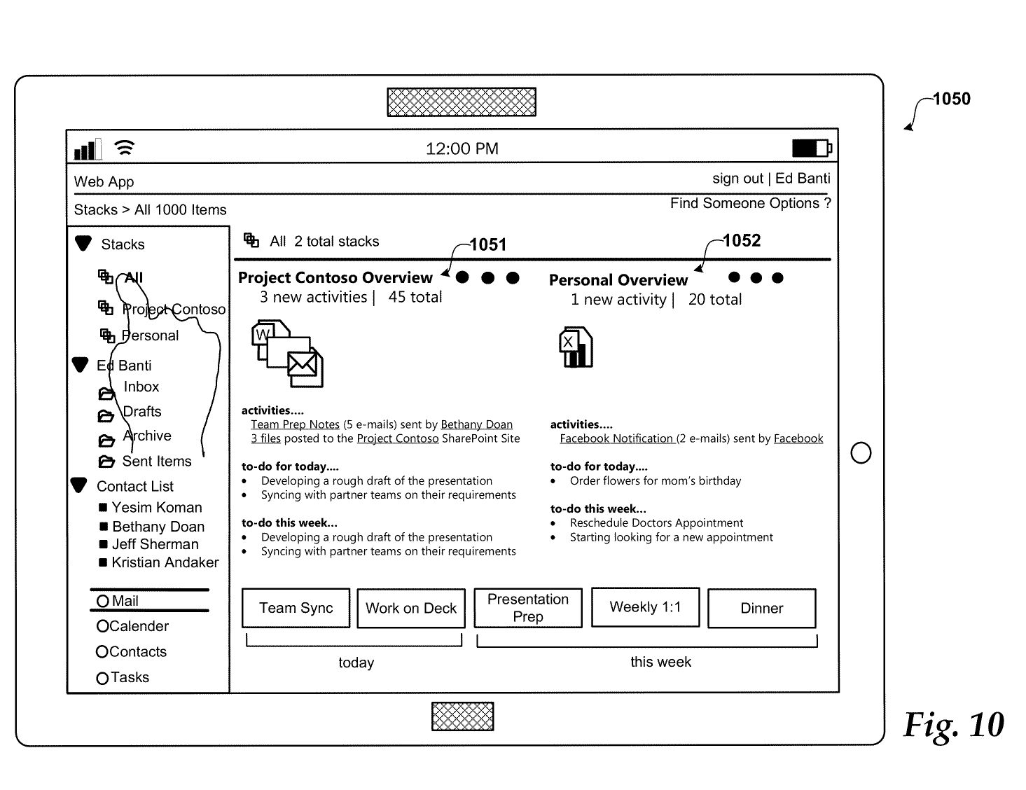

FIG. 10 shows a display 1050 of two stacks including a project stack and a personal stack. In the current example, a user has selected the All stack. In response to selecting the All stack, an overview display of the other stacks (Project Contoso 1051 and Personal 1052 in this example) are displayed. The overview of the display stacks may include a variety of different information. For example, the overview may show all/some of the following: number of new activities; number of total activities; to-do list(s); list of activities; list of communications; people in the project; notes and the like.

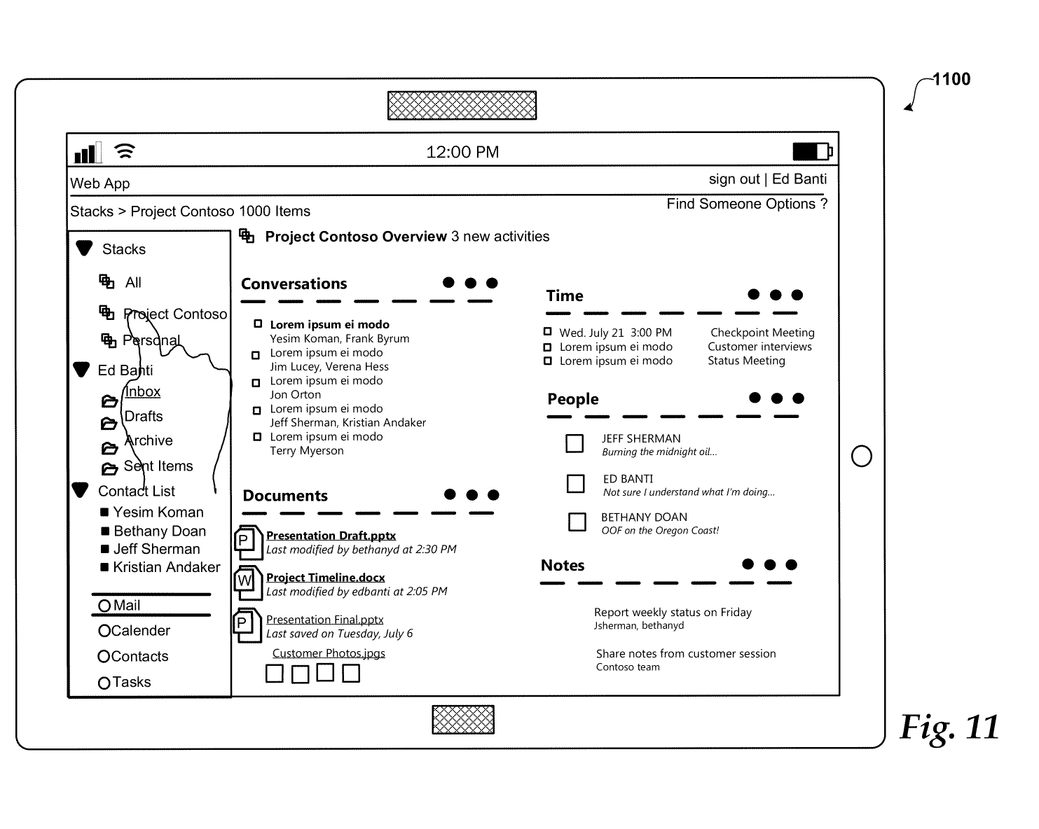

FIG. 11 illustrates an overview page for a stack.

As illustrated, display 1100 shows conversations, times of activities/meetings, people, notes, photos and documents associated with a project. More or less information may be displayed.

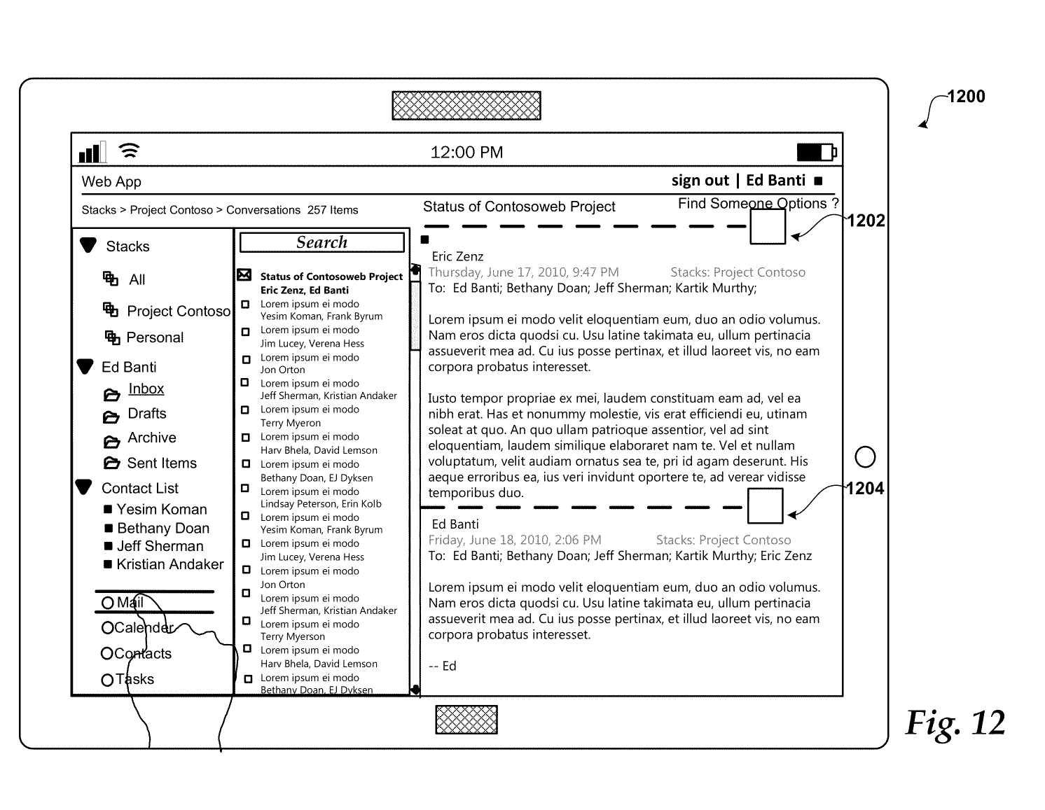

FIG. 12 shows a message that includes a display of an associated stack. As illustrated, a user has selected to view messages. In the current example, a conversation thread is displayed that includes a display of two messages that include a stack user interface element (1202, 1204) that shows the message is associated with a stack. According to an embodiment, the stack user interface element is selectable. When selected, the overview of the stack is displayed.

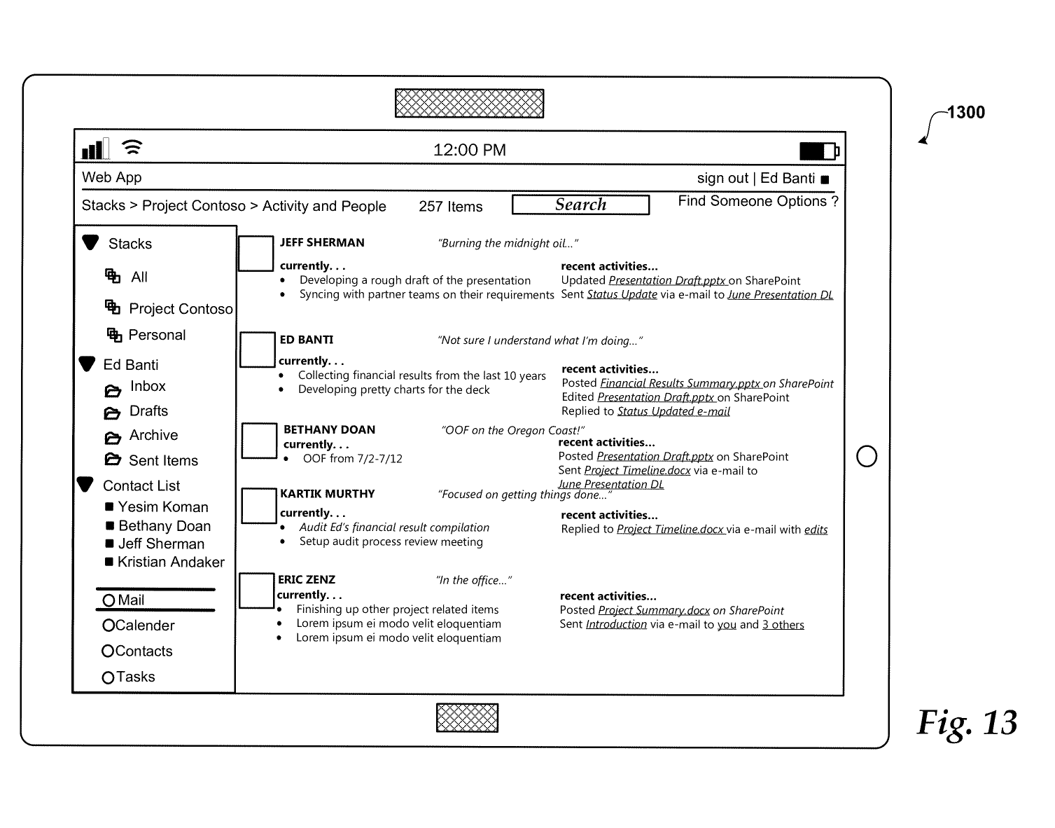

FIG. 13 illustrates a display 1300 of activity and people regarding a project. As shown, a user has selected to see a view of the activity and people related to Project Contoso. The display of the stack related content shows content generated from different applications.

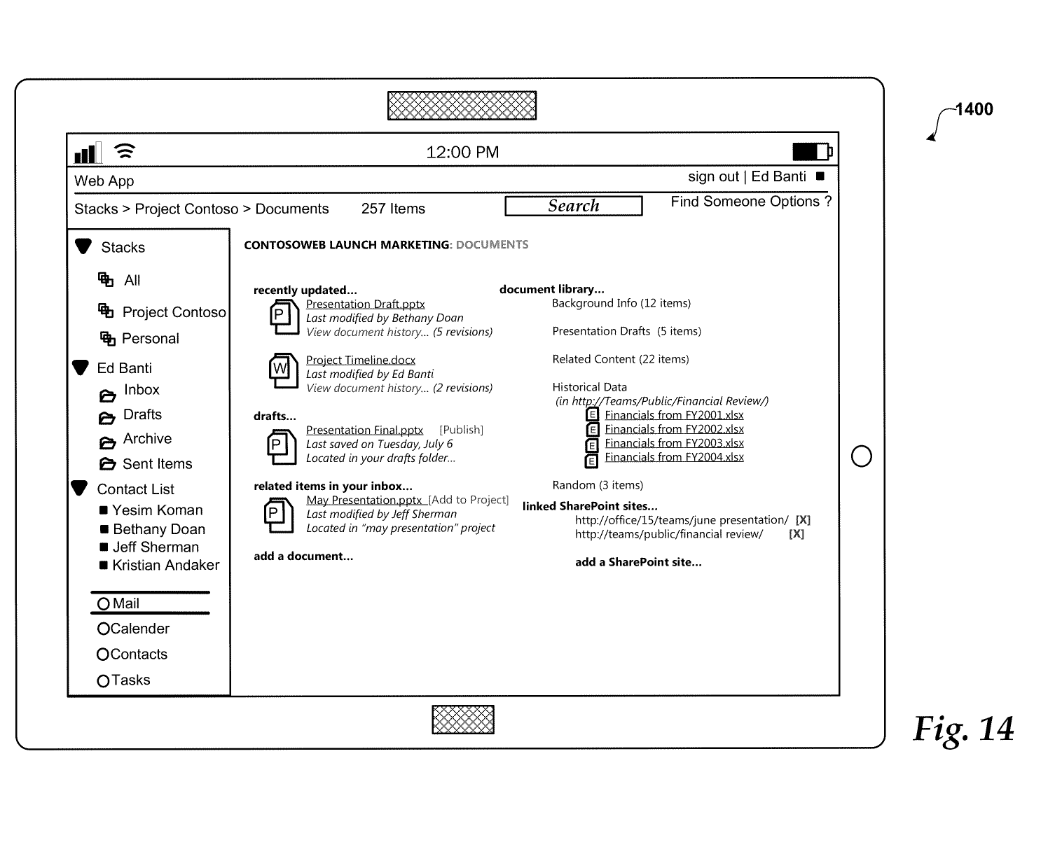

FIG. 14 shows a display 1400 of documents within a project. A user may select one or more of the displayed documents to interact with a document.

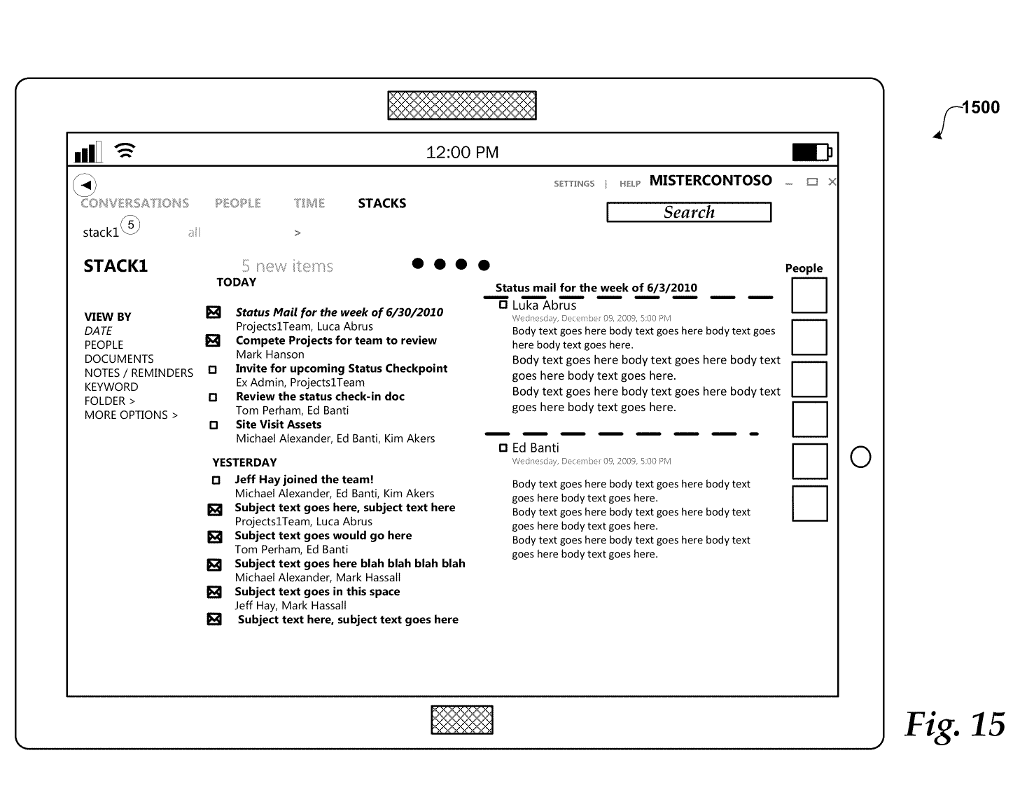

FIG. 15 shows an exemplary display 1500 of a stack for a messaging application.

In the current example, STACK1 is auto-created based on activity in the user's inbox. A user may view a stack according to different filtering parameters. According to an embodiment, a user may select a user interface element 1502 to view a stack by date, people, documents, notes/reminders, keywords and/or other options.

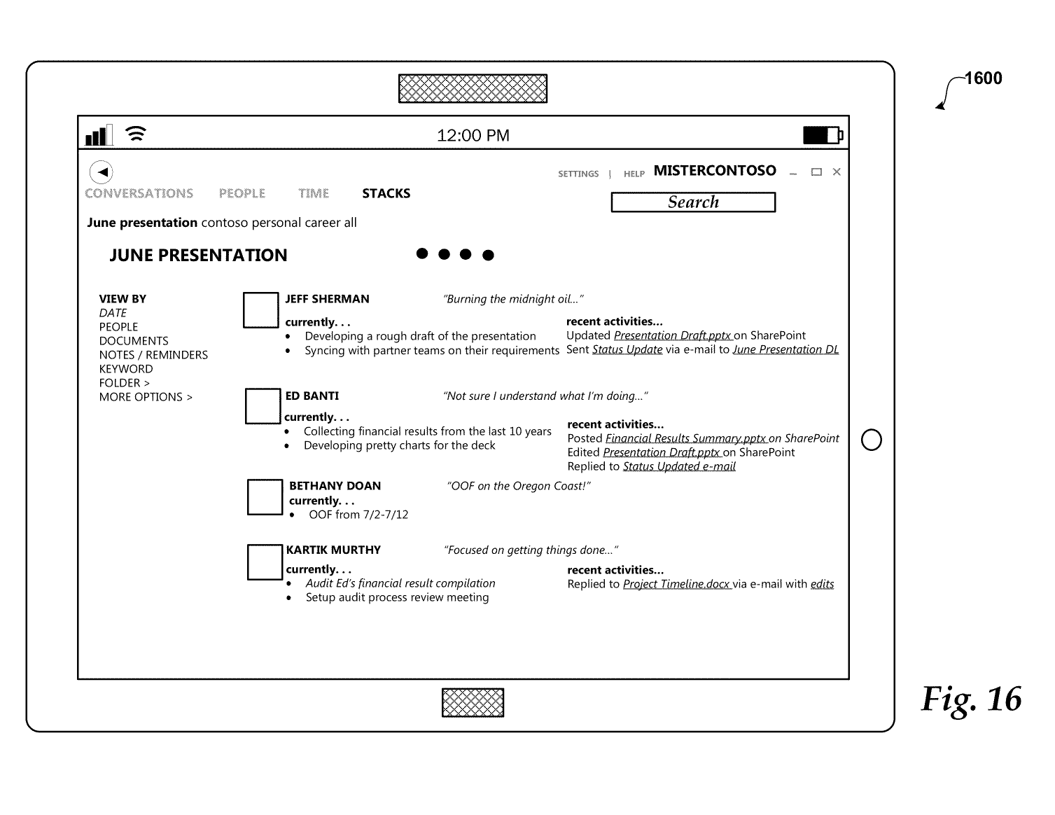

FIG. 16 shows a display of a stack filtered by people. As illustrated, switching from a message view to a people views shows the different people related to the Stack. The view displays a snapshot of what people are doing related to the same activity and includes information such as who is involved, what they're working on, and summaries of recent activities.

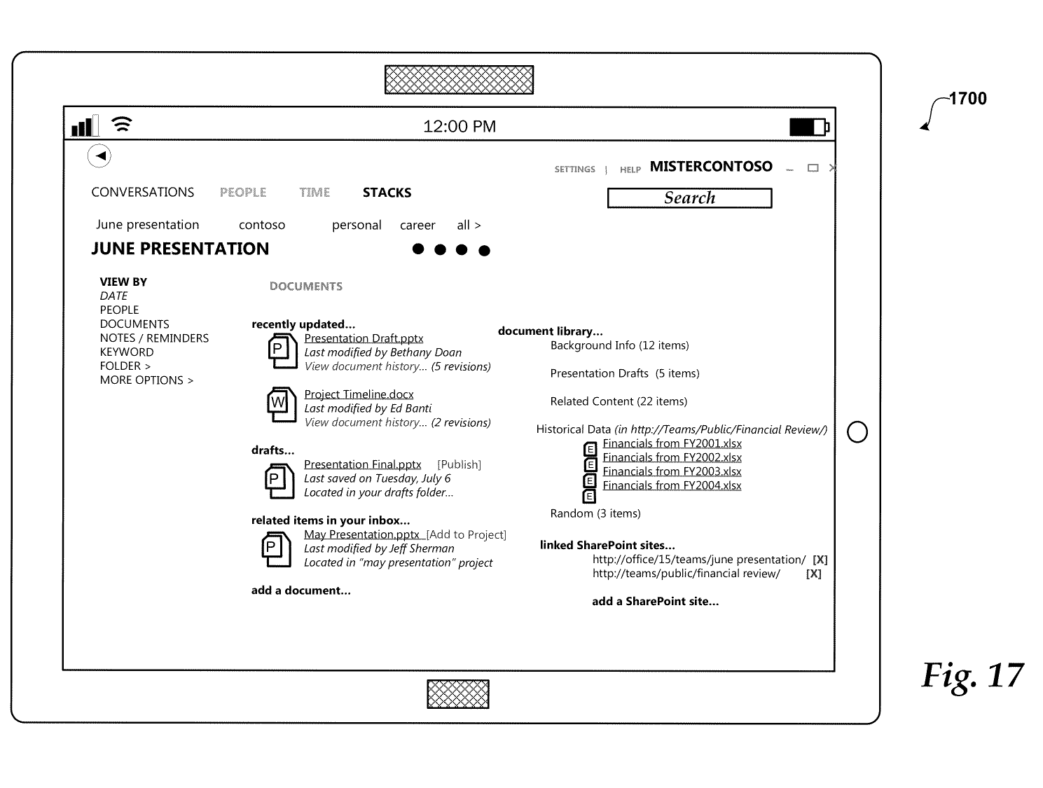

FIG. 17 shows stacks for documents.

The document view shows a view of documents across a user's inbox, drafts, document libraries, content sites, which contain related documents and are associated with a stack.

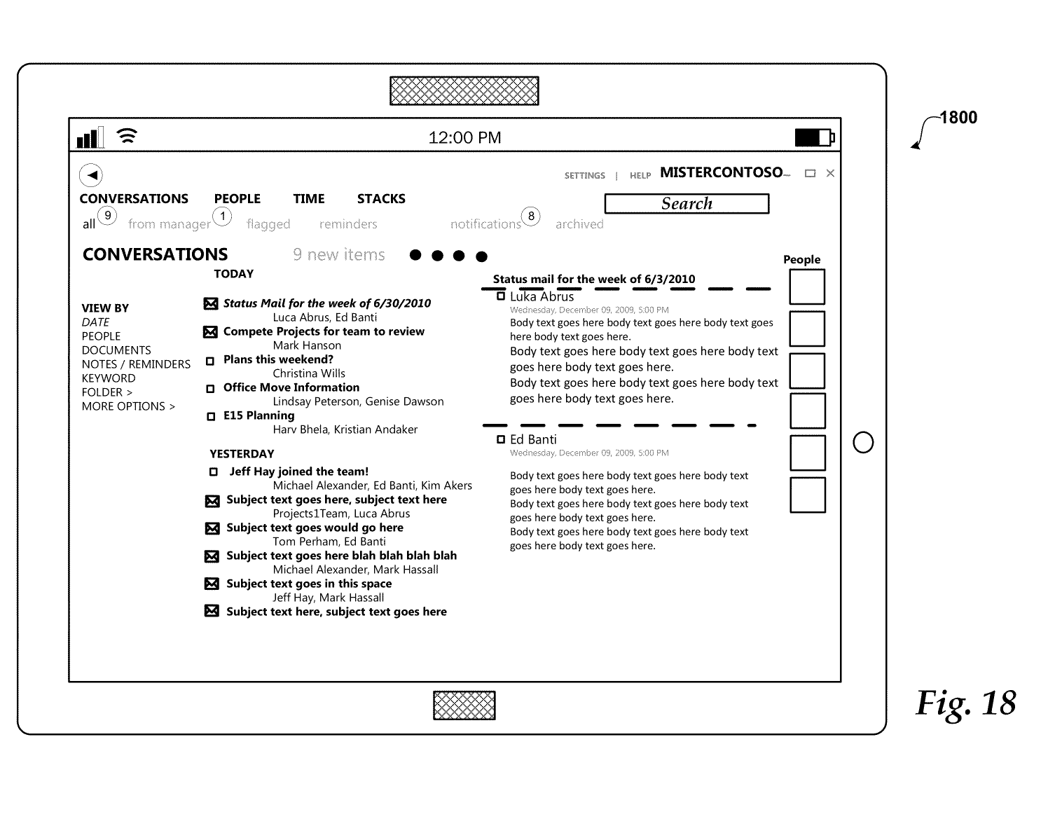

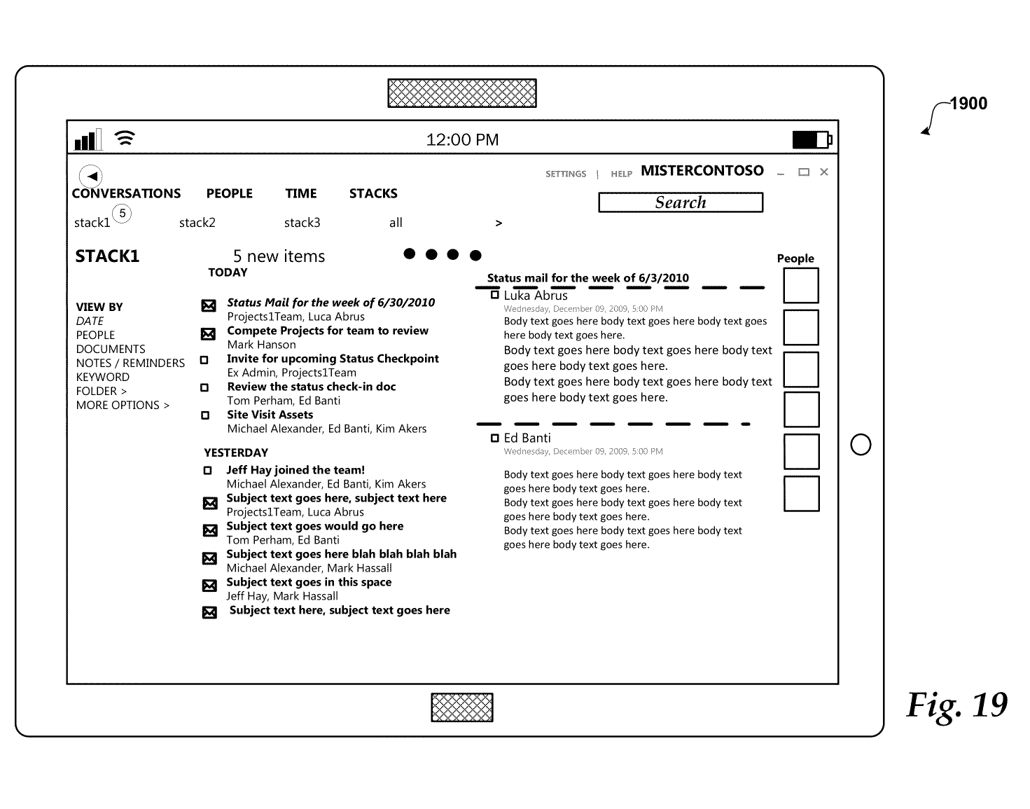

FIGS. 18-24 illustrate naming a stack.

FIG. 18 illustrates an initial display before naming a stack within a messaging application.

FIG. 19 illustrates an initial display 1900 of a stack. In this example, the default stack names are stack1, stack2 and stack 3. Other default stack names may be used.

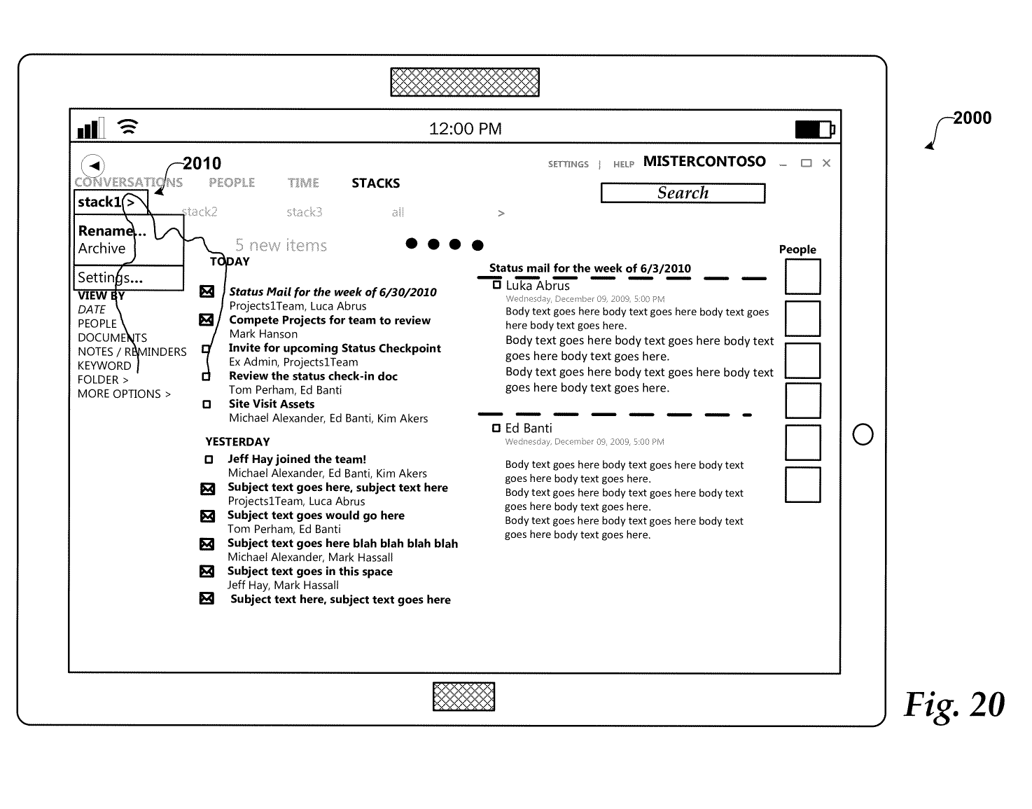

FIG. 20 illustrates selection of a UI element related to the stack. As illustrated, a user has touched “stack1” in display 2000. In response, UI menu 2010 is displayed that includes various options including a “Rename . . . ” option.

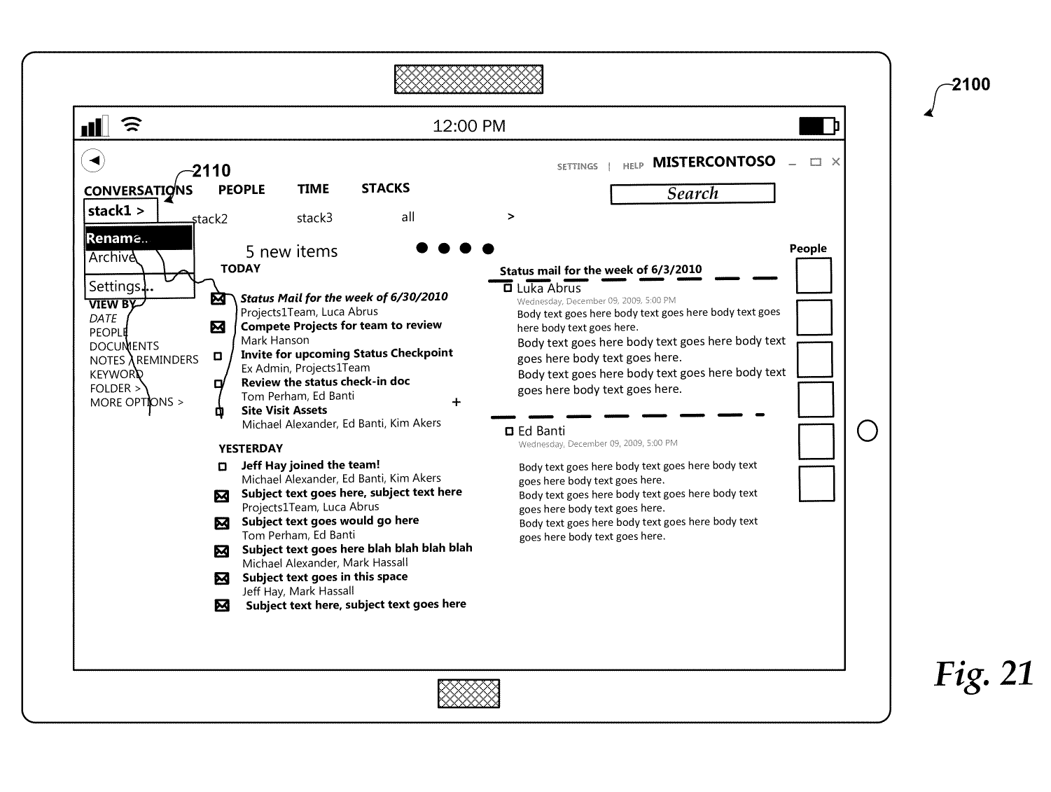

FIG. 21 illustrates a user selecting the rename option 2110 in a menu on display 2100.

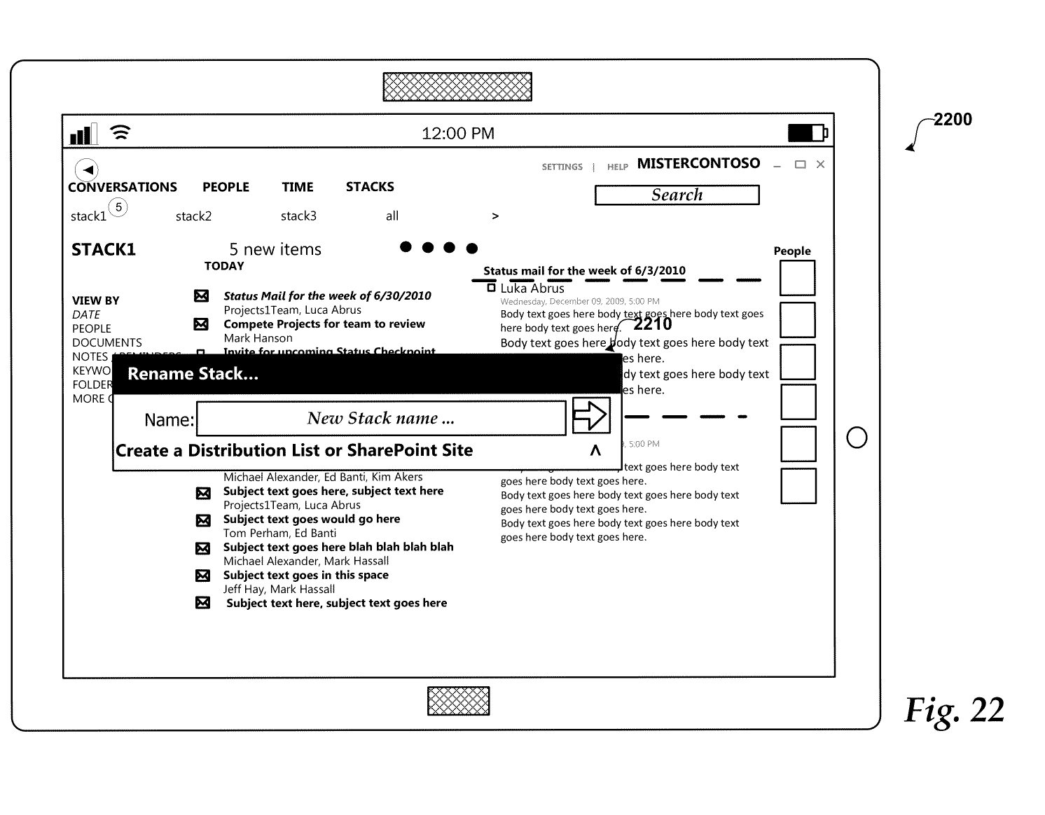

FIG. 22 illustrates a display 2200 showing a UI element 2210 for entering a name for the stack.

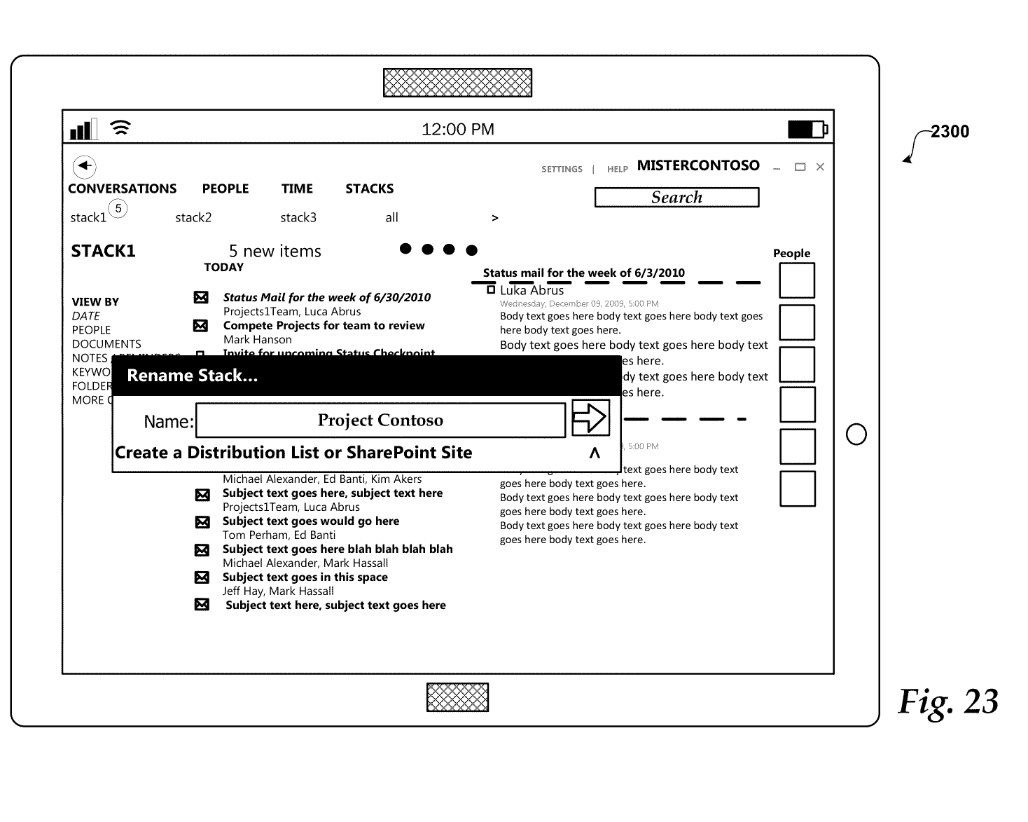

FIG. 23 illustrates a display 2300 showing a user entering a name for the stack.

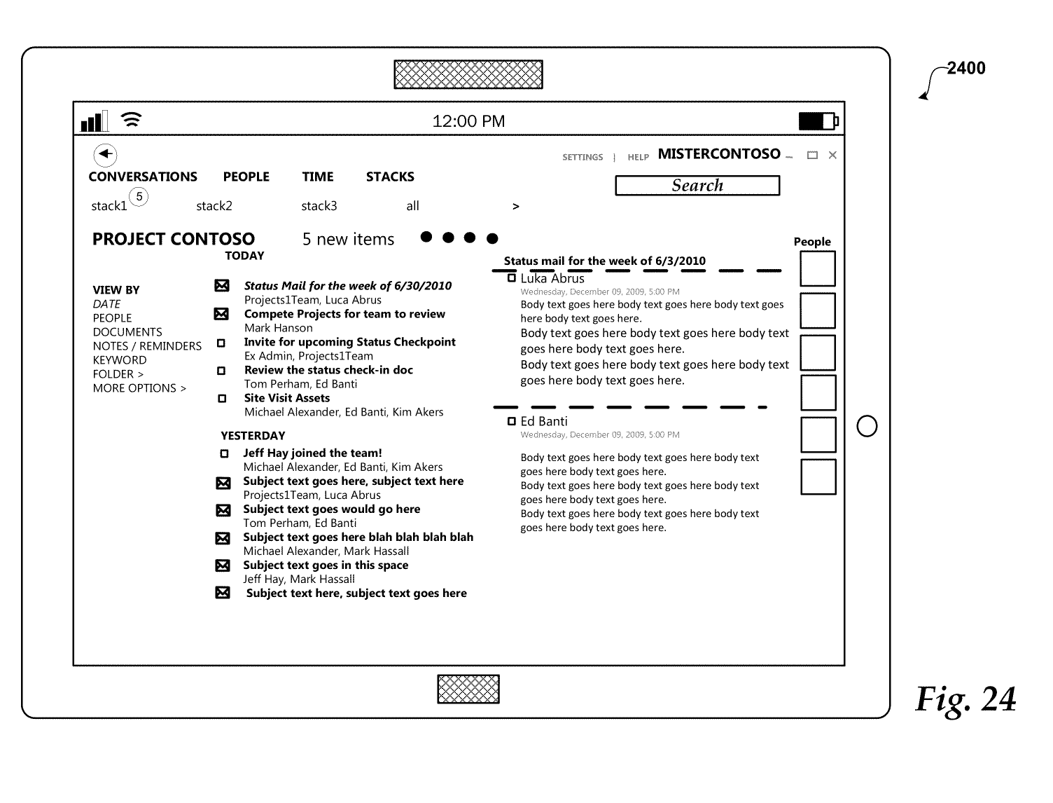

FIG. 24 illustrates a display 2400 showing a stack renamed.

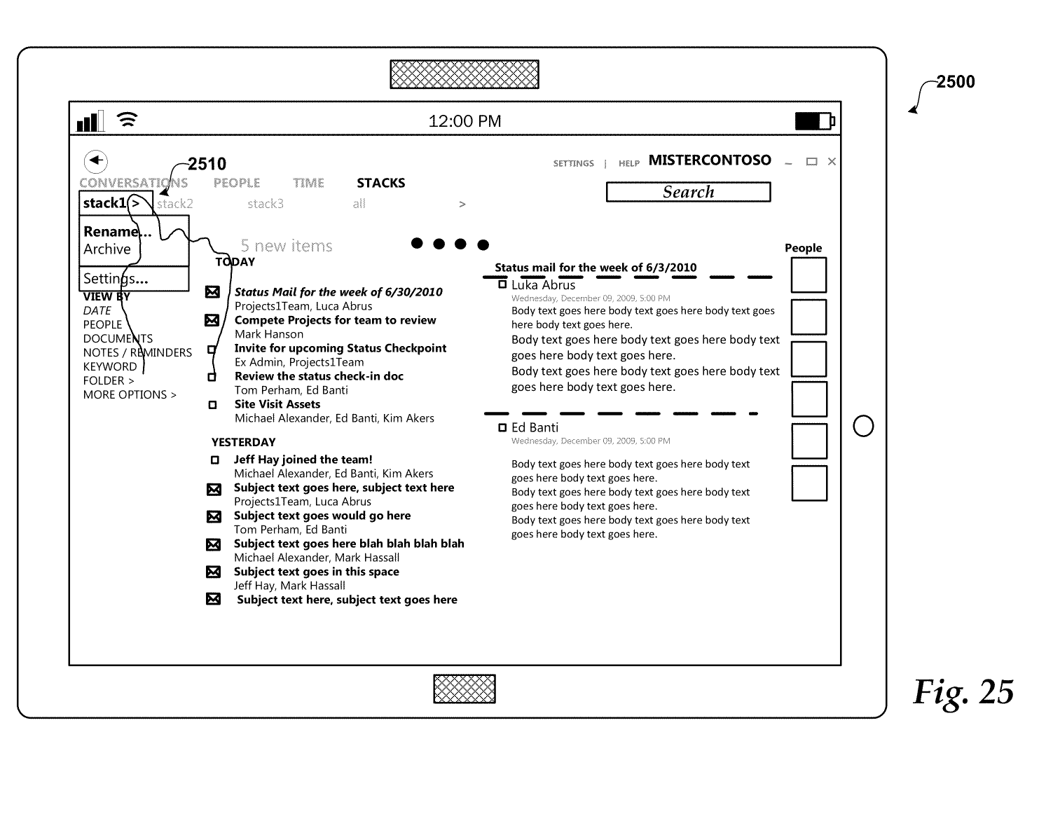

FIGS. 25-30 show linking a stack to an application and a distribution list (DL). In addition to manually specifying information, stacks are configured to automatically collect content links (e.g. links to a content site) that are within the stack and weakly associate them with the stack. The following figures show manual selection.

FIG. 25 illustrates a display showing a UI element used when linking a stack and creating a distribution list. As illustrated, a user has touched “stack1” in display 2500. In response, UI menu 2510 is displayed that includes various options including a “Rename . . . ” option.

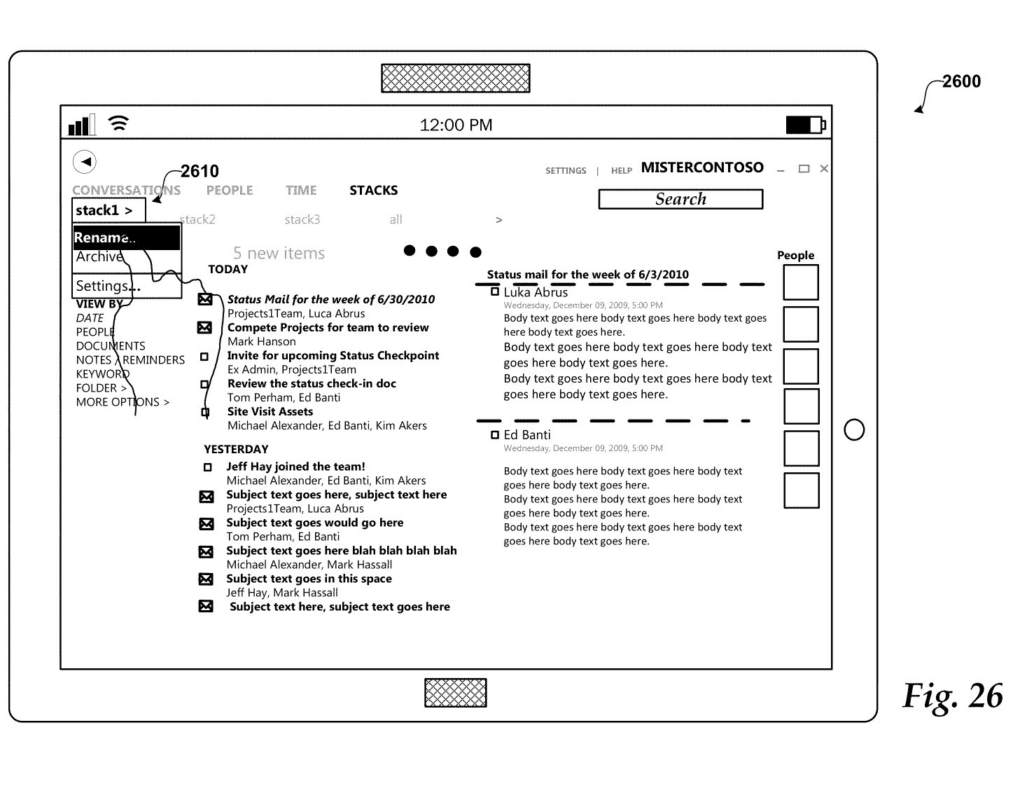

FIG. 26 illustrates a user selecting the rename option 2610 in a menu on display 2600.

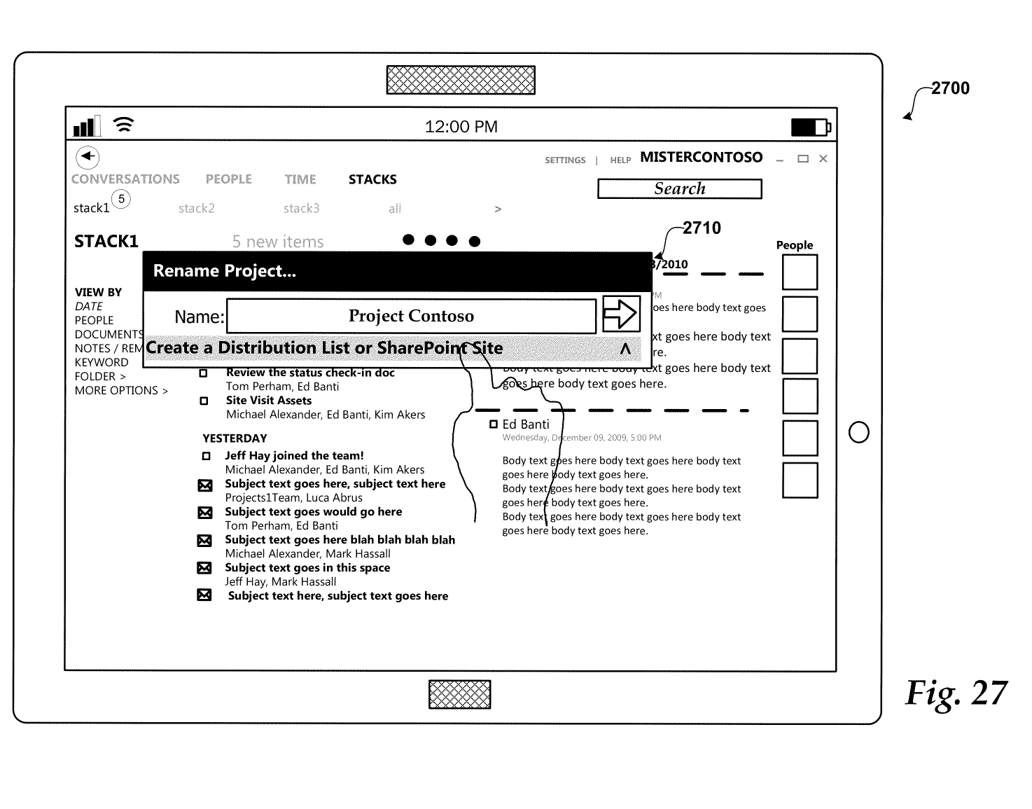

FIG. 27 illustrates a display 2700 showing a UI element 2710 for entering a name for the stack and/or creating a distribution list or content site (e.g. a SHAREPOINT site). In the current example, a user has selected the “Create a Distribution List or Content Site” Option.

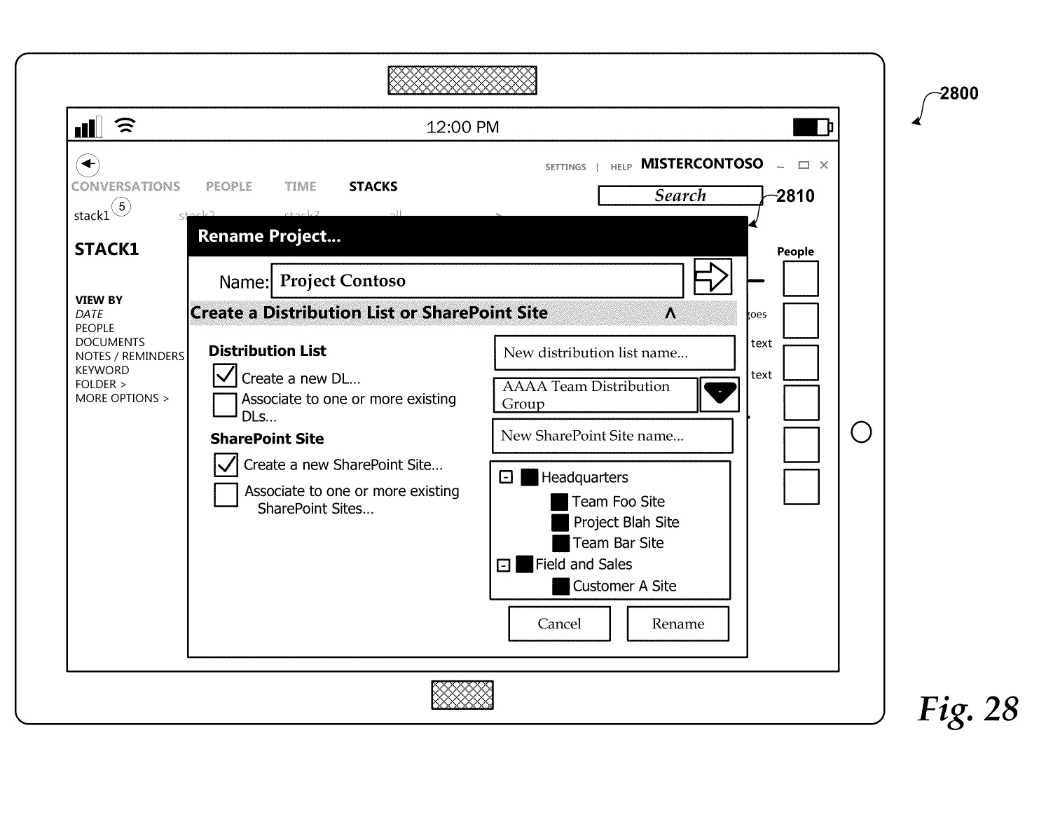

FIG. 28 illustrates a display 2800 showing UI options 2810. UI options 2810 include options for creating a new distribution list and/or a new content site.

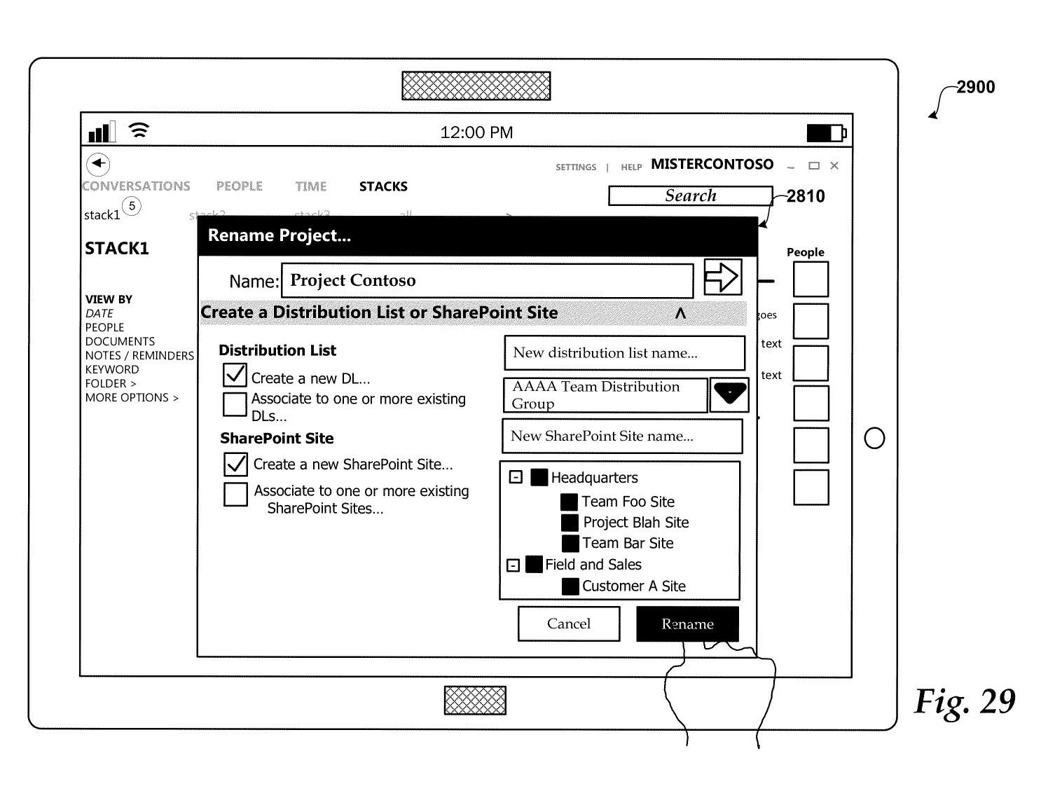

FIG. 29 illustrates a display 2900 showing a user selecting the rename option to create the distribution list and content site.

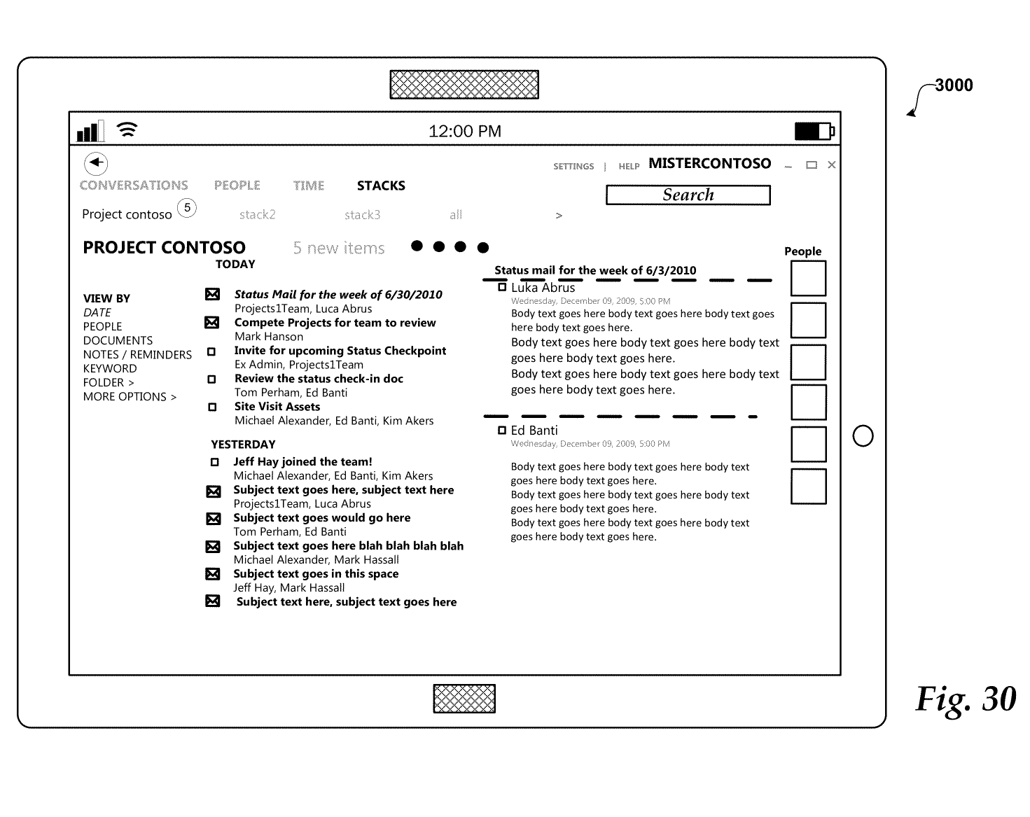

FIGS. 30-32 illustrate manually adding items to a stack.

FIG. 30 shows an initial display 3000.

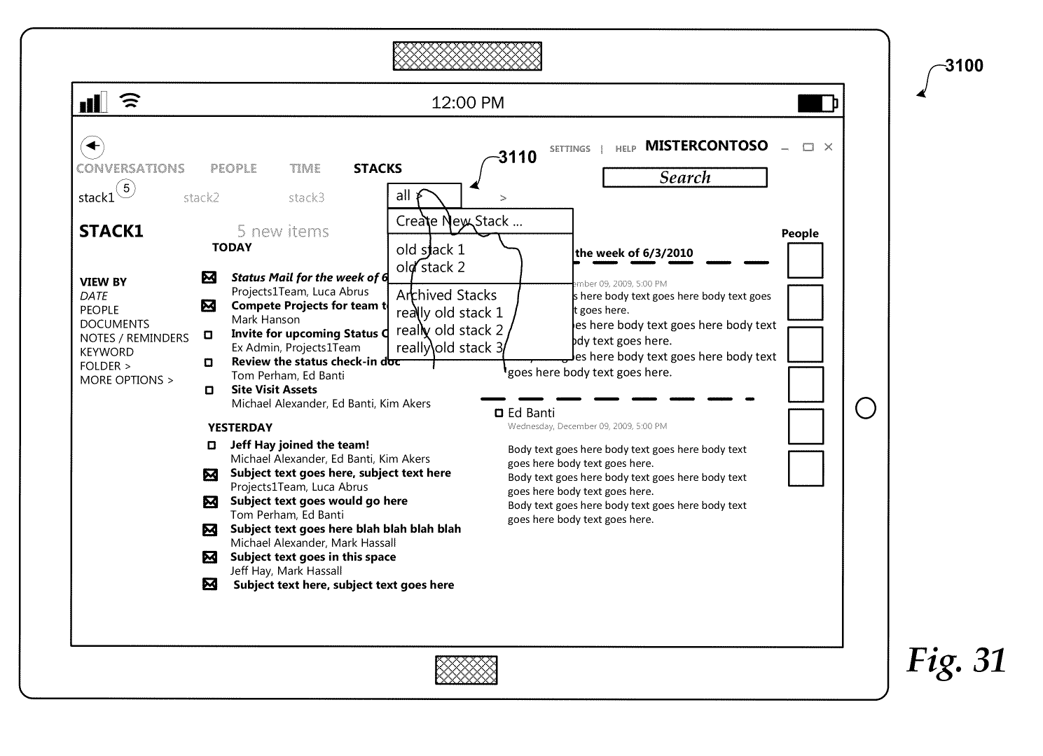

FIG. 31 shows a user selecting the “all” stack option 3110 on display 3100.

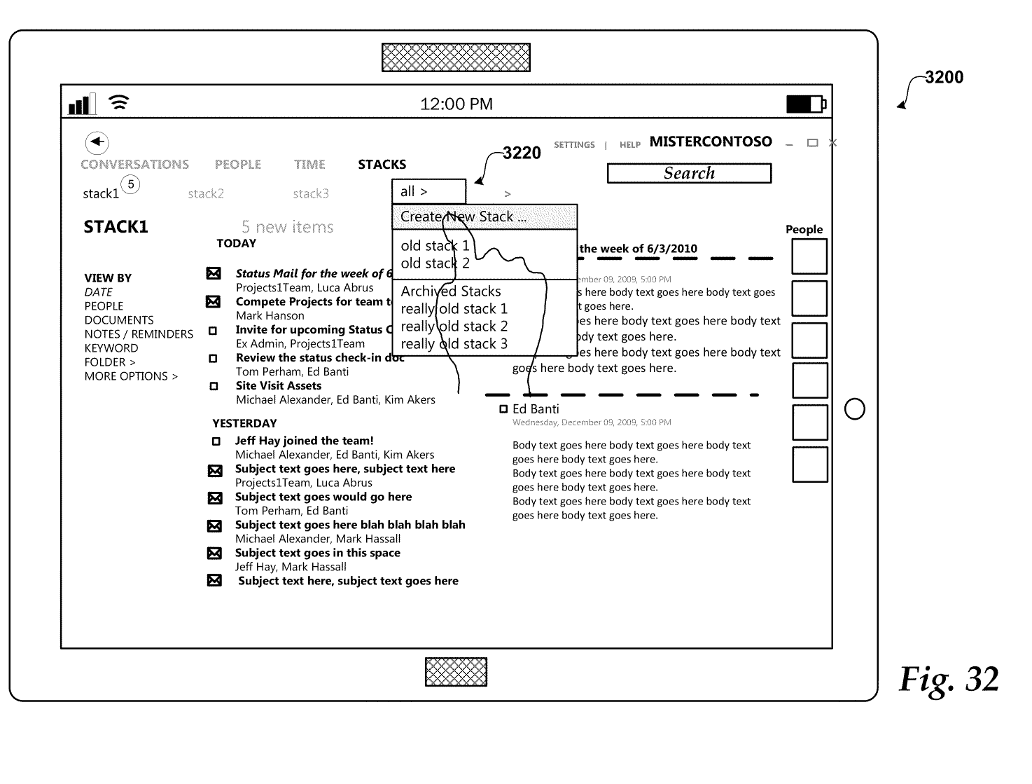

FIG. 32 illustrates a user selecting the “Create New Stack” option 3210 on display 3200.

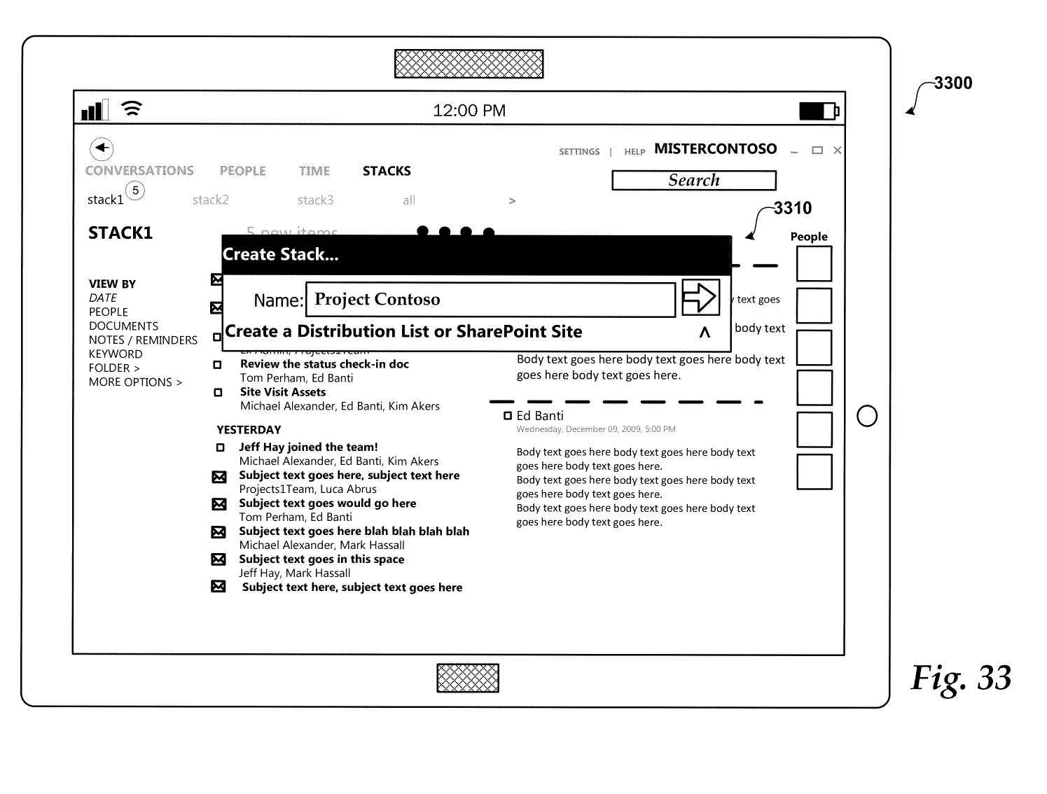

FIG. 33 illustrates a user entering a name for a stack using UI 3310 on display 3300.

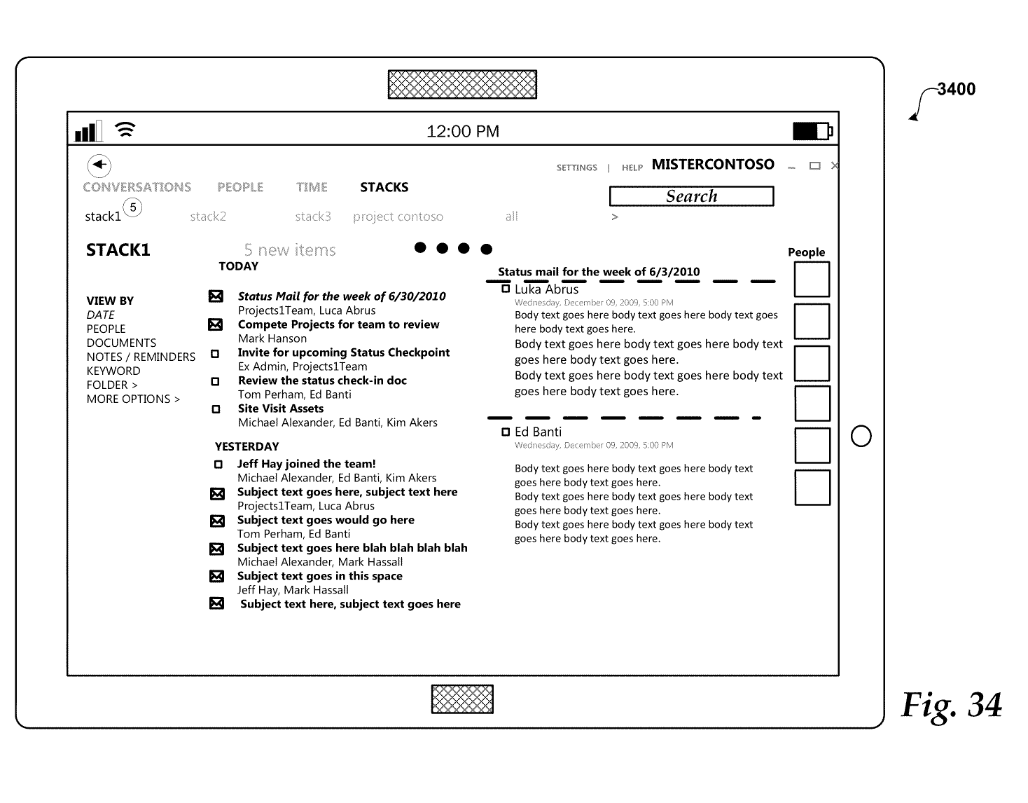

FIG. 34 illustrates stack “Project Contoso” after being created on display 3400.

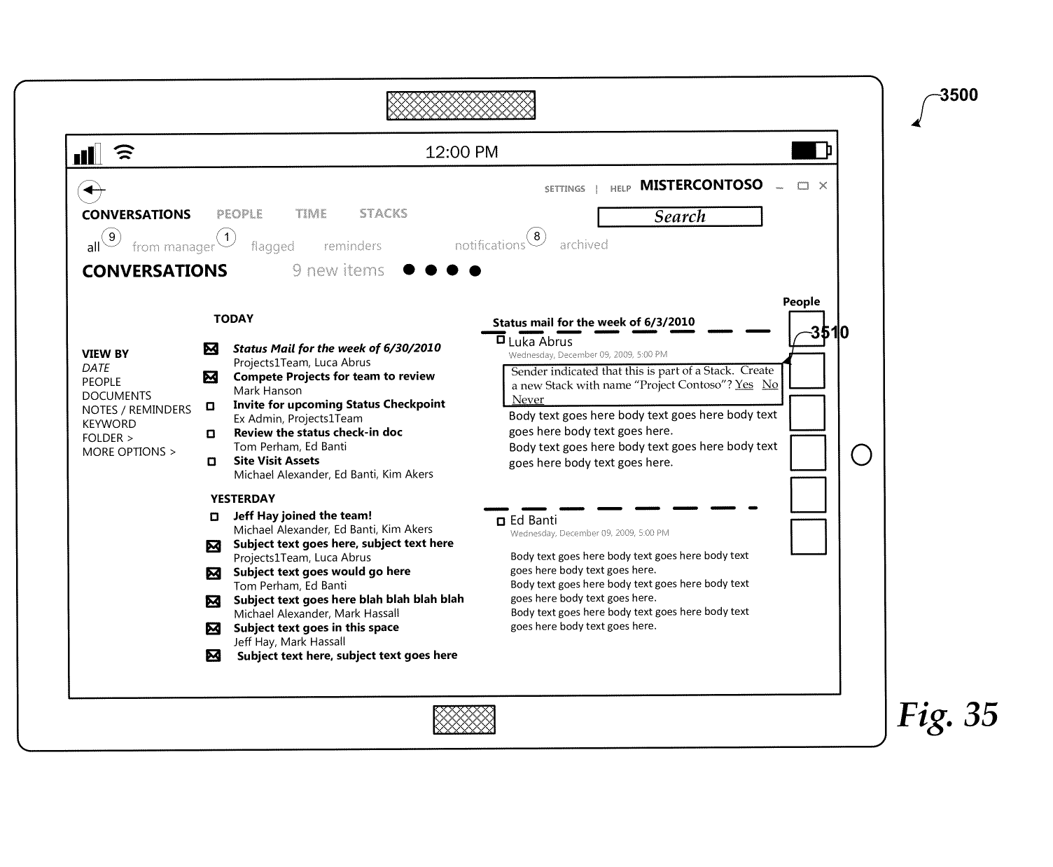

FIG. 35 illustrates sharing stacks. As illustrated, the sender of a message has indicated that the message is part of a stack and has requested from the user using UI element 3510 whether or not they would like to create a corresponding stack.

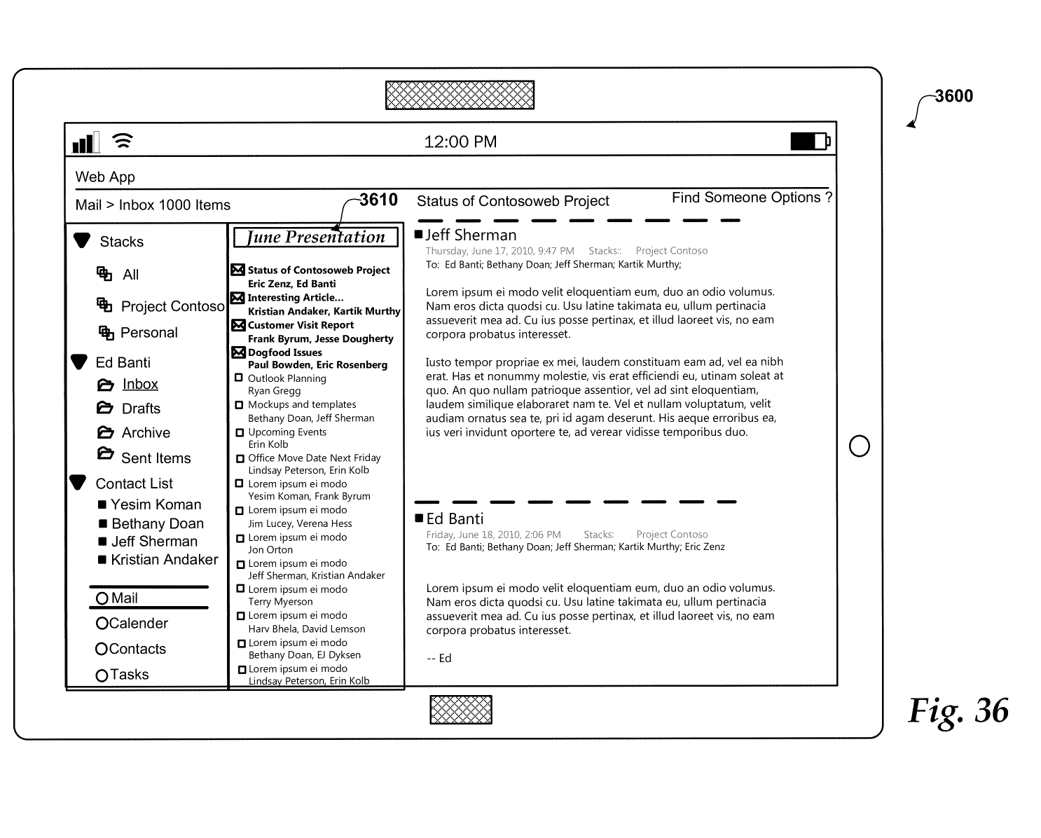

FIGS. 36-42 illustrate creating stacks ad-hoc.

FIG. 36 illustrates display 3600 that shows a view within a messaging application in which a user has entered a search term “June Presentation” in search box 3610.

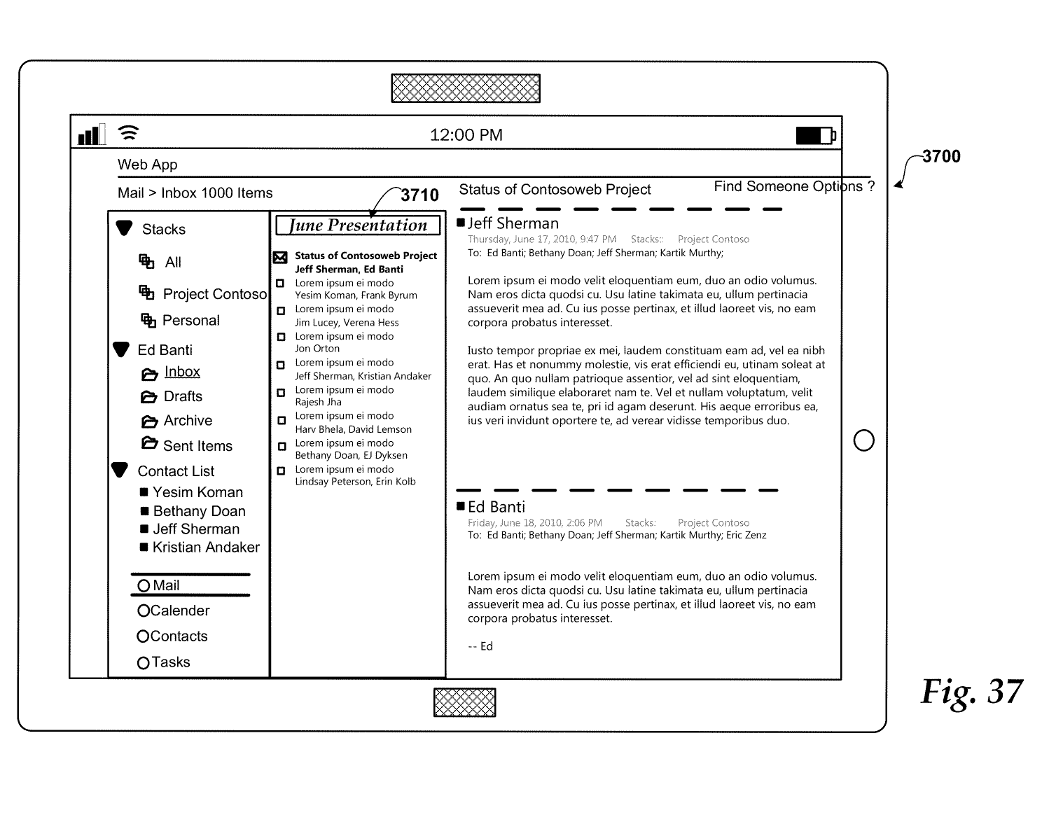

FIG. 37 illustrates display 3700 that shows the search results returned 3710.

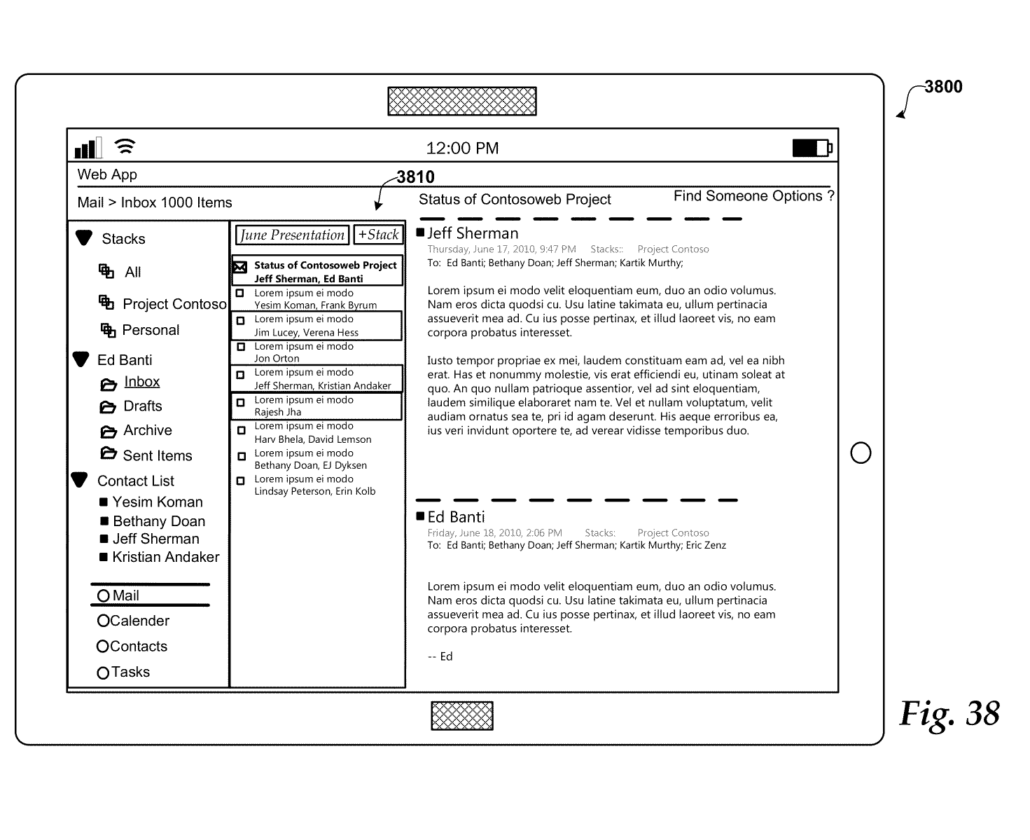

FIG. 38 illustrates display 3800 that shows a user selection of items to include within a new stack. As illustrated, a user selects the stack user interface element 3810 to create a new stack. According to an embodiment, a stack is created using the selected items and is named using the search term (e.g. in this case “June Presentation”). According to another embodiment, the user may specify a name through a UI element.

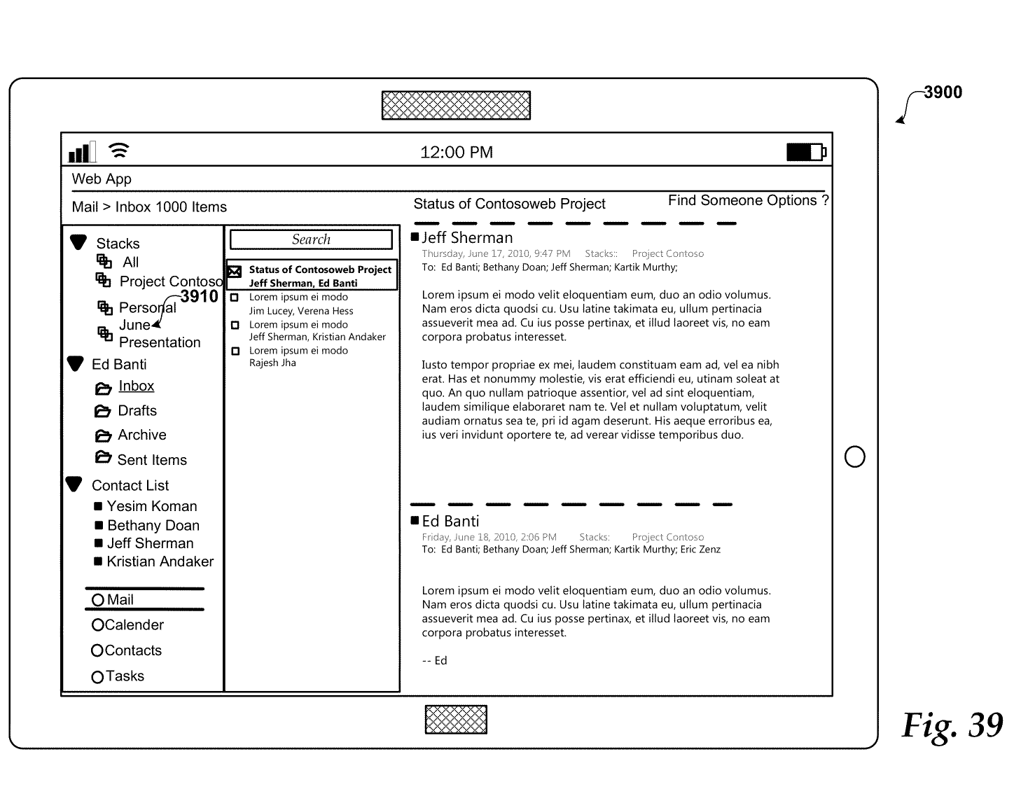

FIG. 39 illustrates display 3900 that shows the June Presentation Stack 3910 created and containing the selected items as illustrated in FIG. 38. According to an embodiment, the newly created is automatically assigned a color within the display.

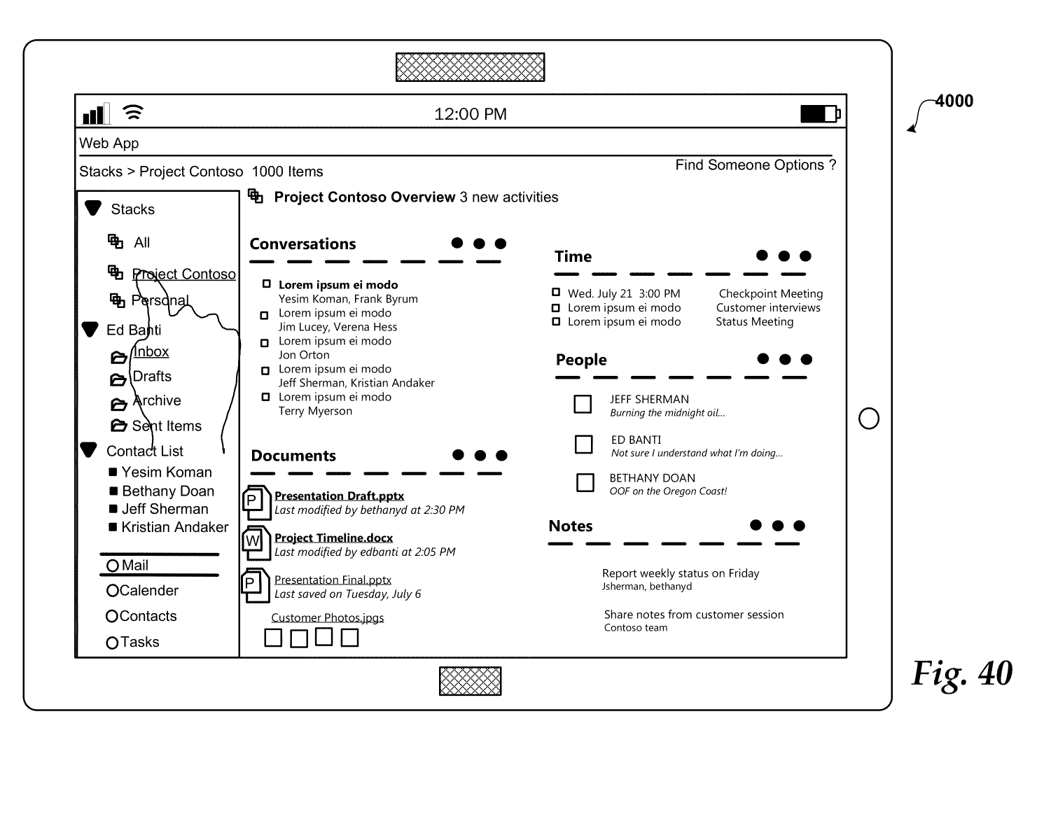

FIG. 40 illustrates display 4000 that shows a user selecting to view the Project Contoso stack. As a result of selecting the Project Contoso stack, the display shows a summary of the contents of the stack, including messages, meetings, people, documents, and notes.

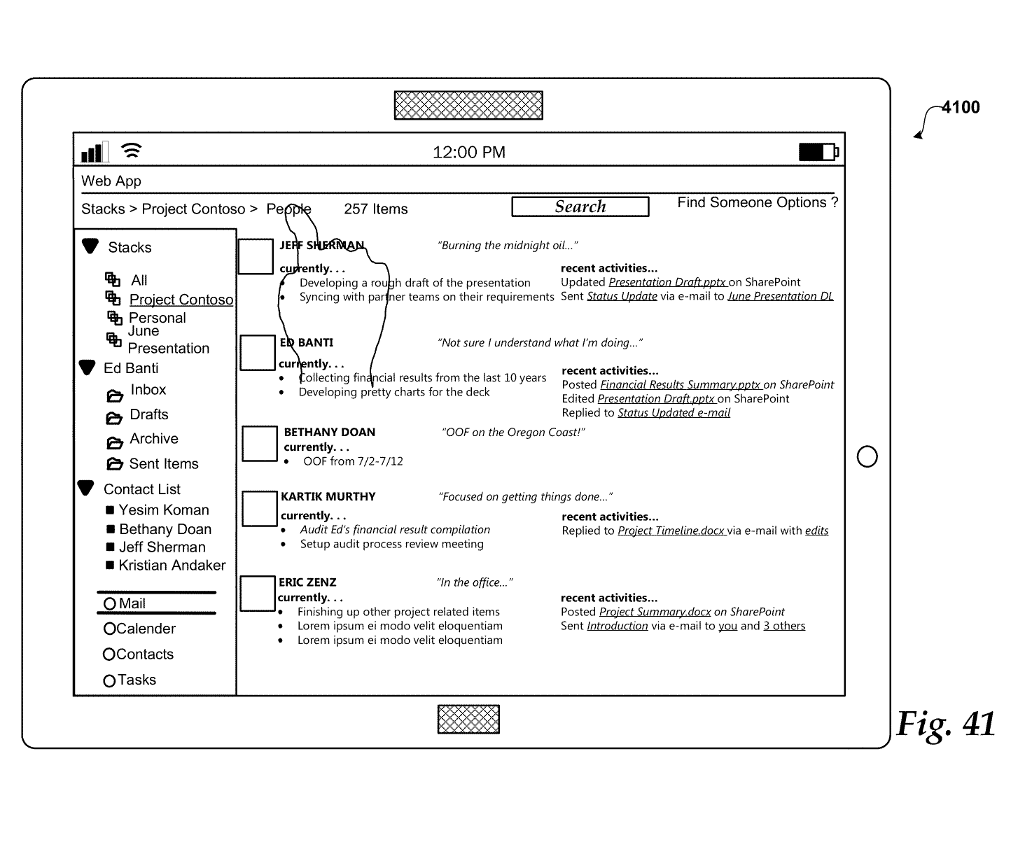

FIG. 41 illustrates display 4100 that shows a user selecting to view the people associated with the Project Contoso stack. As illustrated, selecting the People UI element displays the people related to Project Contoso and what they're currently working on/doing.

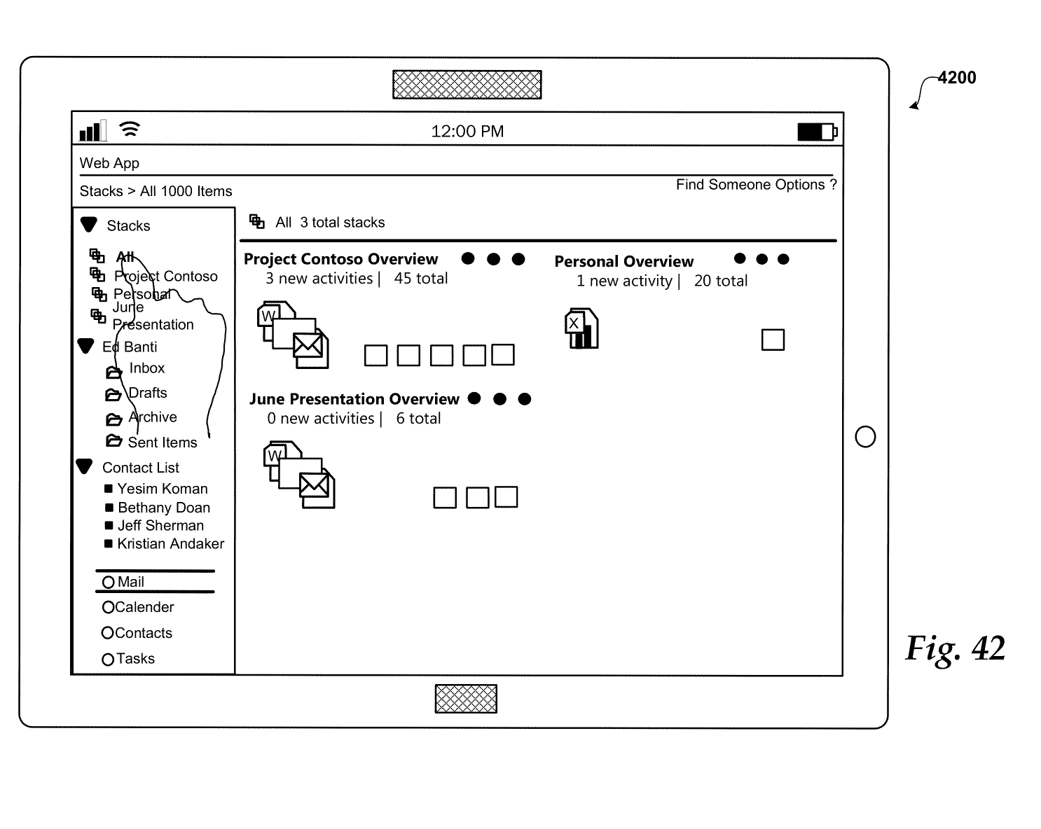

FIG. 42 illustrates display 4200 that shows a user selecting to view a summary of all of the stacks. According to an embodiment, selecting the All Stack displays a snapshot of each stack including new items, related people, and total activities.

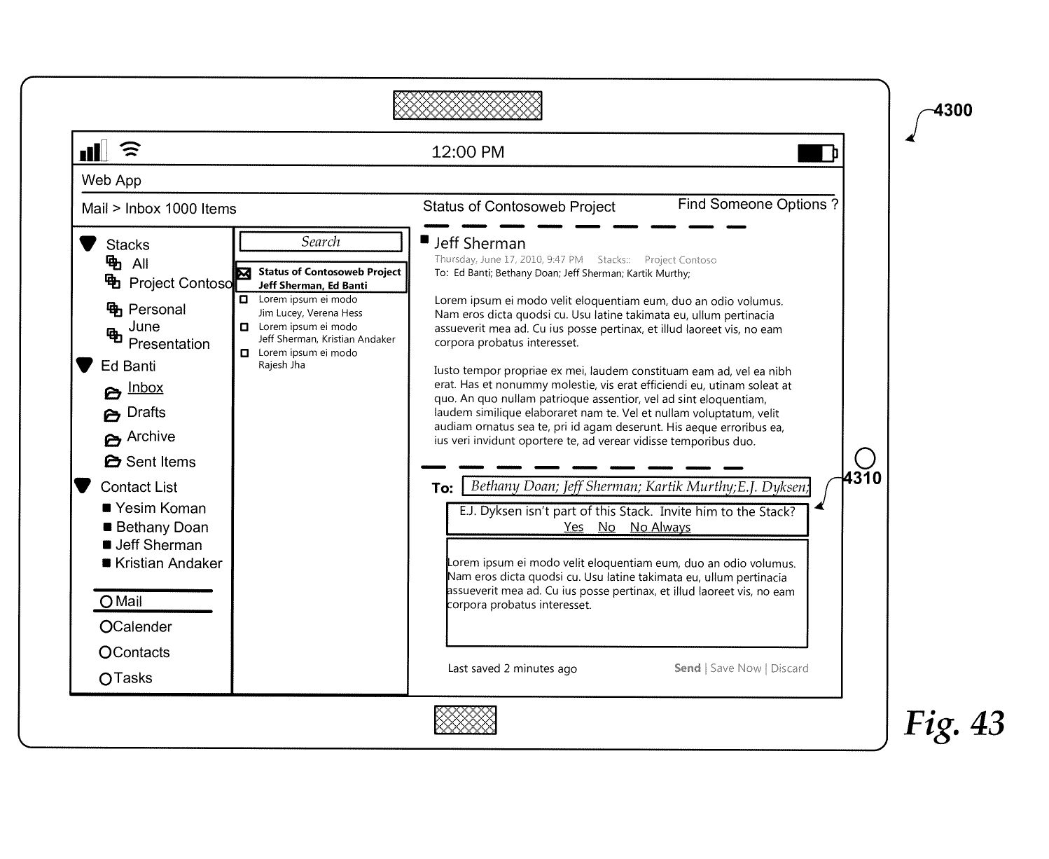

FIG. 43 illustrates display 4300 that shows a user creating a message that is associated with a stack. As illustrated, the first three addressees are part of the stack and the fourth addressee “E. J. Dyksen” is not currently associated with the stack. In response to detecting that a person is not associated with a stack, a UI element (such as UI element 4310) is displayed that asks whether or not to add the person to the stack.

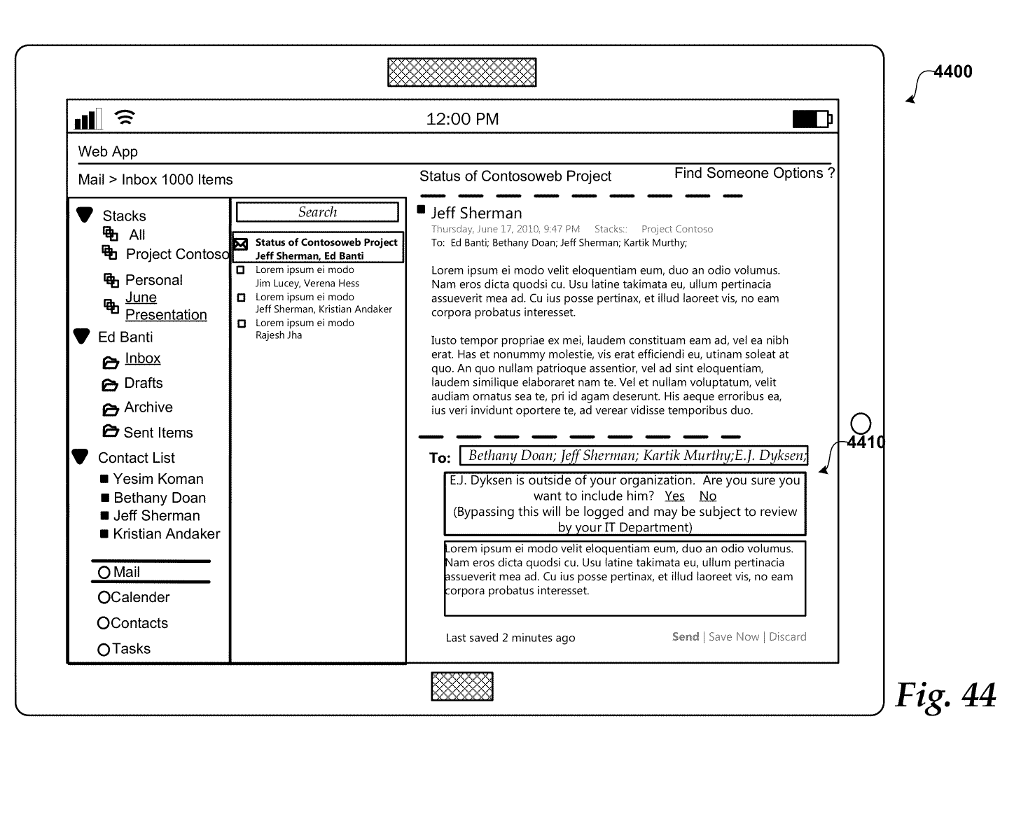

FIG. 44 illustrates display 4400 that shows a user addressing a message to a person that is not associated with the stack and is outside of the organization. As illustrated, the first three addressees are part of the stack and the fourth addressee “E. J. Dyksen” is not currently associated with the stack and is outside of the organization. In response to detecting that a person is not associated with a stack and is outside of the organization or some other trusted source, a UI element (such as UI element 4410) is displayed that asks whether or not to add the person to the stack even though they are outside of the organization.

The embodiments and functionalities described herein may operate via a multitude of computing systems, including wired and wireless computing systems, mobile computing systems (e.g., mobile telephones, tablet or slate type computers, laptop computers, etc.). In addition, the embodiments and functionalities described herein may operate over distributed systems, where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

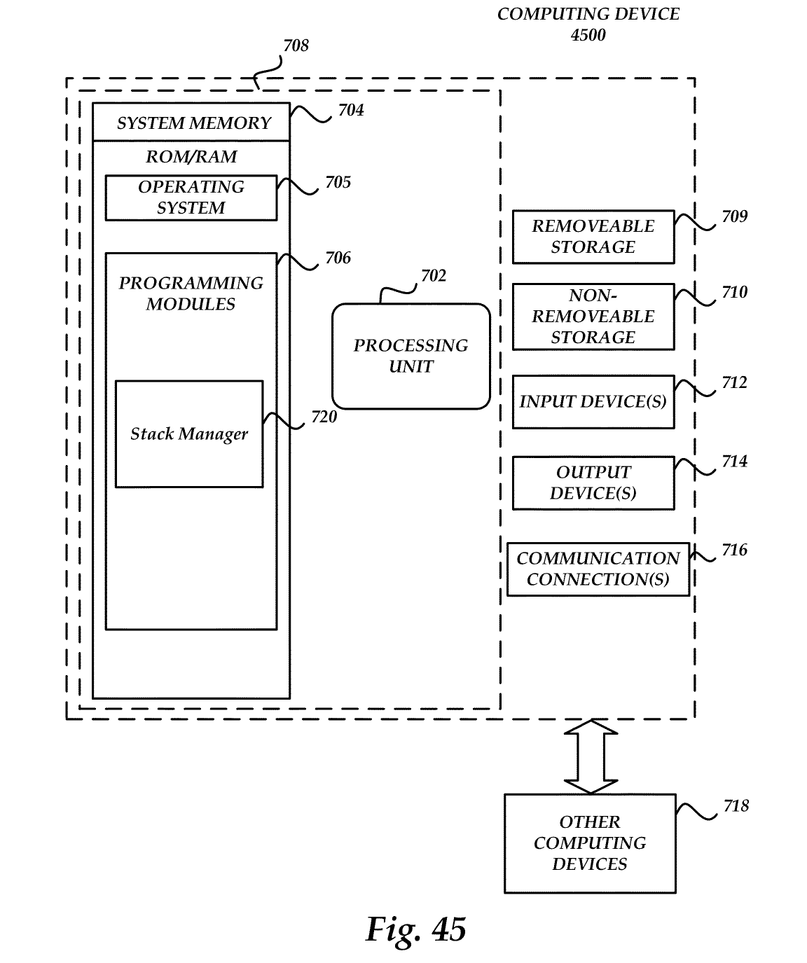

FIGS. 45-47 and the associated descriptions provide a discussion of a variety of operating environments in which embodiments of the invention may be practiced. However, the devices and systems illustrated and discussed with respect to FIGS. 45-47 are for purposes of example and illustration and are not limiting of a vast number of computing device configurations that may be utilized for practicing embodiments of the invention, described herein.

FIG. 45 is a block diagram illustrating example physical components of a computing device 4500 with which embodiments of the invention may be practiced. The computing device components described below may be suitable for the computing devices described above. In a basic configuration, computing device 4500 may include at least one processing unit 702 and a system memory 704. Depending on the configuration and type of computing device, system memory 704 may comprise, but is not limited to, volatile (e.g. random access memory (RAM)), non-volatile (e.g. read-only memory (ROM)), flash memory, or any combination. System memory 704 may include operating system 705, one or more programming modules 706, and may include a web browser application 720. Operating system 705, for example, may be suitable for controlling computing device 4500's operation. In one embodiment, programming modules 706 may include a stack manager 720, as described above, installed on computing device 4500. Furthermore, embodiments of the invention may be practiced in conjunction with a graphics library, other operating systems, or any other application program and is not limited to any particular application or system. This basic configuration is illustrated in FIG. 45 by those components within a dashed line 708.

Computing device 4500 may have additional features or functionality. For example, computing device 4500 may also include additional data storage devices (removable and/or non-removable) such as, for example, magnetic disks, optical disks, or tape. Such additional storage is illustrated in FIG. 45 by a removable storage 709 and a non-removable storage 710.

As stated above, a number of program modules and data files may be stored in system memory 704, including operating system 705. While executing on processing unit 702, programming modules 706, such as the stack manager may perform processes including, for example, one or more methods as described above. The aforementioned process is an example, and processing unit 702 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 45 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the manager 720 may be operated via application-specific logic integrated with other components of the computing device/system 4500 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process.

The term computer readable media as used herein may include computer storage media. Computer storage media may include volatile and nonvolatile, removable and non-removable media implemented in any method or technology for storage of information, such as computer readable instructions, data structures, program modules, or other data. System memory 704, removable storage 709, and non-removable storage 710 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 4500. Any such computer storage media may be part of device 4500. Computing device 4500 may also have input device(s) 712 such as a keyboard, a mouse, a pen, a sound input device, a touch input device, etc. Output device(s) 714 such as a display, speakers, a printer, etc. may also be included. The aforementioned devices are examples and others may be used.

A camera and/or some other sensing device may be operative to record one or more users and capture motions and/or gestures made by users of a computing device. Sensing device may be further operative to capture spoken words, such as by a microphone and/or capture other inputs from a user such as by a keyboard and/or mouse (not pictured). The sensing device may comprise any motion detection device capable of detecting the movement of a user. For example, a camera may comprise a MICROSOFT KINECT® motion capture device comprising a plurality of cameras and a plurality of microphones.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

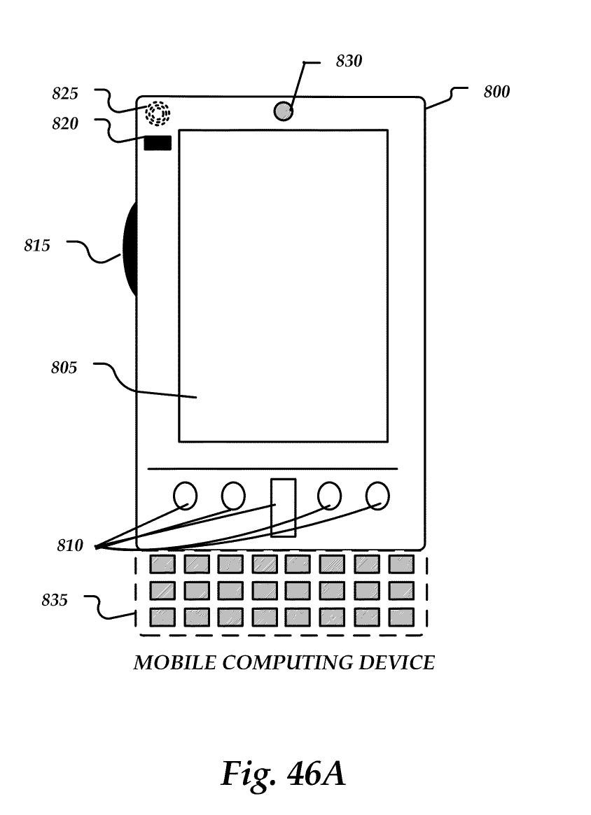

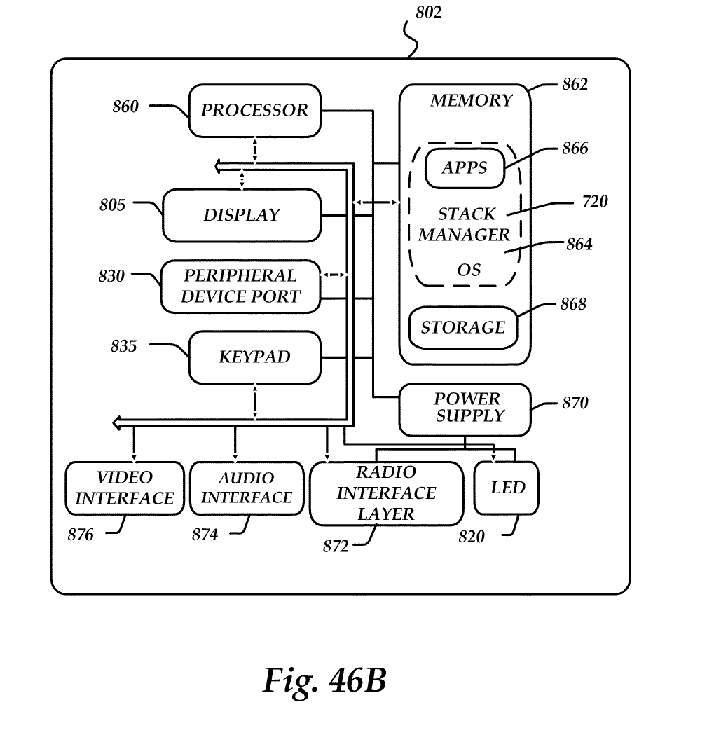

FIGS. 46A and 46B illustrate a suitable mobile computing environment, for example, a mobile telephone, a smartphone, a tablet personal computer, a laptop computer, and the like, with which embodiments of the invention may be practiced. With reference to FIG. 46A, an example mobile computing device 800 for implementing the embodiments is illustrated. In a basic configuration, mobile computing device 800 is a handheld computer having both input elements and output elements. Input elements may include touch screen display 805 and input buttons 815 that allow the user to enter information into mobile computing device 800. Mobile computing device 800 may also incorporate an optional side input element 815 allowing further user input. Optional side input element 815 may be a rotary switch, a button, or any other type of manual input element. In alternative embodiments, mobile computing device 800 may incorporate more or less input elements. For example, display 805 may not be a touch screen in some embodiments. In yet another alternative embodiment, the mobile computing device is a portable phone system, such as a cellular phone having display 805 and input buttons 815. Mobile computing device 800 may also include an optional keypad 835. Optional keypad 815 may be a physical keypad or a “soft” keypad generated on the touch screen display.

Mobile computing device 800 incorporates output elements, such as display 805, which can display a graphical user interface (GUI). Other output elements include speaker 825 and LED light 820. Additionally, mobile computing device 800 may incorporate a vibration module (not shown), which causes mobile computing device 800 to vibrate to notify the user of an event. In yet another embodiment, mobile computing device 800 may incorporate a headphone jack (not shown) for providing another means of providing output signals.

Although described herein in combination with mobile computing device 800, in alternative embodiments the invention is used in combination with any number of computer systems, such as in desktop environments, laptop or notebook computer systems, multiprocessor systems, micro-processor based or programmable consumer electronics, network PCs, mini computers, main frame computers and the like. Embodiments of the invention may also be practiced in distributed computing environments where tasks are performed by remote processing devices that are linked through a communications network in a distributed computing environment; programs may be located in both local and remote memory storage devices. To summarize, any computer system having a plurality of environment sensors, a plurality of output elements to provide notifications to a user and a plurality of notification event types may incorporate embodiments of the present invention.

FIG. 46B is a block diagram illustrating components of a mobile computing device used in one embodiment, such as the computing device shown in FIG. 46A. That is, mobile computing device 800 can incorporate system 802 to implement some embodiments. For example, system 802 can be used in implementing a “smart phone” that can run one or more applications similar to those of a desktop or notebook computer such as, for example, browser, e-mail, scheduling, instant messaging, and media player applications. In some embodiments, system 802 is integrated as a computing device, such as an integrated personal digital assistant (PDA) and wireless phone.

One or more application programs 866 may be loaded into memory 862 and run on or in association with operating system 864. Examples of application programs include phone dialer programs, e-mail programs, PIM (personal information management) programs, word processing programs, spreadsheet programs, Internet browser programs, messaging programs, and so forth. System 802 also includes non-volatile storage 868 within memory 862. Non-volatile storage 868 may be used to store persistent information that should not be lost if system 802 is powered down. Applications 866 may use and store information in non-volatile storage 868, such as e-mail or other messages used by an e-mail application, and the like. A synchronization application (not shown) may also reside on system 802 and is programmed to interact with a corresponding synchronization application resident on a host computer to keep the information stored in non-volatile storage 868 synchronized with corresponding information stored at the host computer. As should be appreciated, other applications may be loaded into memory 862 and run on the device 800, including the stack manager 720, described above.

System 802 has a power supply 870, which may be implemented as one or more batteries. Power supply 870 might further include an external power source, such as an AC adapter or a powered docking cradle that supplements or recharges the batteries.

System 802 may also include a radio 872 that performs the function of transmitting and receiving radio frequency communications. Radio 872 facilitates wireless connectivity between system 802 and the “outside world”, via a communications carrier or service provider. Transmissions to and from radio 872 are conducted under control of OS 864. In other words, communications received by radio 872 may be disseminated to application programs 866 via OS 864, and vice versa.

Radio 872 allows system 802 to communicate with other computing devices, such as over a network. Radio 872 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

This embodiment of system 802 is shown with two types of notification output devices; LED 820 that can be used to provide visual notifications and an audio interface 874 that can be used with speaker 825 to provide audio notifications. These devices may be directly coupled to power supply 870 so that when activated, they remain on for a duration dictated by the notification mechanism even though processor 860 and other components might shut down for conserving battery power. LED 820 may be programmed to remain on indefinitely until the user takes action to indicate the powered-on status of the device. Audio interface 874 is used to provide audible signals to and receive audible signals from the user. For example, in addition to being coupled to speaker 825, audio interface 874 may also be coupled to a microphone 820 to receive audible input, such as to facilitate a telephone conversation. In accordance with embodiments of the present invention, the microphone 820 may also serve as an audio sensor to facilitate control of notifications, as will be described below. System 802 may further include video interface 876 that enables an operation of on-board camera 830 to record still images, video stream, and the like.

A mobile computing device implementing system 802 may have additional features or functionality. For example, the device may also include additional data storage devices (removable and/or non-removable) such as, magnetic disks, optical disks, or tape. Such additional storage is illustrated in FIG. 10B by storage 868. Computer storage media may include volatile and nonvolatile, removable and non-removable media implemented in any method or technology for storage of information, such as computer readable instructions, data structures, program modules, or other data.

Data/information generated or captured by the device 800 and stored via the system 802 may be stored locally on the device 800, as described above, or the data may be stored on any number of storage media that may be accessed by the device via the radio 872 or via a wired connection between the device 800 and a separate computing device associated with the device 800, for example, a server computer in a distributed computing network such as the Internet. As should be appreciated such data/information may be accessed via the device 800 via the radio 872 or via a distributed computing network. Similarly, such data/information may be readily transferred between computing devices for storage and use according to well-known data/information transfer and storage means, including electronic mail and collaborative data/information sharing systems.

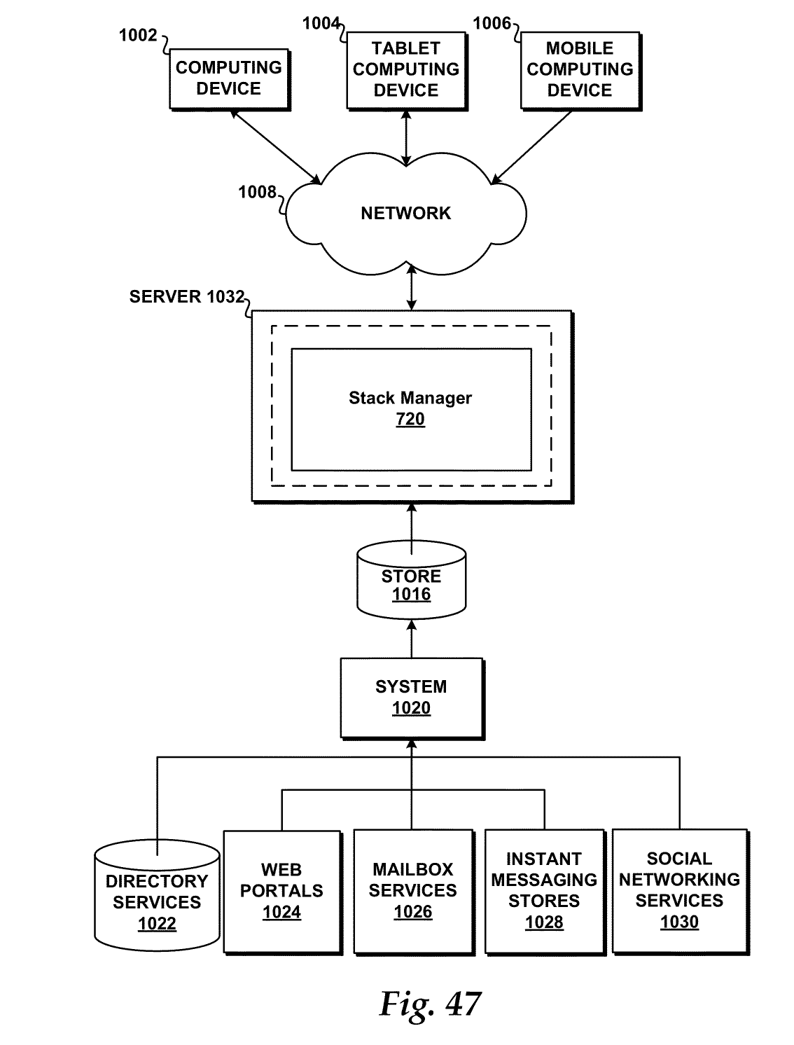

FIG. 47 illustrates a system architecture for interacting with and creating stacks, as described above.

Components managed via the stack manager 720 may be stored in different communication channels or other storage types. For example, components along with information from which they are developed may be stored using directory services 1022, web portals 1024, mailbox services 1026, instant messaging stores 1028 and social networking sites 1030. The systems/applications 720, 1020 may use any of these types of systems or the like for enabling management and storage of components in a store 1016. A server 1032 may provide communications for managed components and content to clients. As one example, server 1032 may be a web server providing collaborative display component management communications and content over the web. Server 1032 may provide online display component management and content over the web to clients through a network 1008. Examples of clients that may obtain display component management communications and content include computing device 1002, which may include any general purpose personal computer, a tablet computing device 1004 and/or mobile computing device 1006 which may include smart phones. Any of these devices may obtain display component management communications and content from the store 1016.

Embodiments of the present invention are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for organizing electronic content, comprising:
displaying a stack user interface element that represents a stack that relates electronic content that comprise messages and documents across different applications;
receiving an interaction with the stack UI element that requests a view of the stack to be displayed;
accessing the stack that associates the electronic content using tags; and
displaying a summary of the electronic content that is associated with the stack.

2. The method of claim 1, wherein the electronic content comprises people, calendar events, documents, and electronic messages that is tagged to be associated with at least the stack.

3. The method of claim 2, wherein displaying the electronic content that is associated with the stack comprises displaying a single view of the electronic content across different systems.

4. The method of claim 3, wherein the different systems comprise an electronic messaging system and a content system.

5. The method of claim 1, wherein the stack comprises a personal stack and a system stack.

6. The method of claim 5, wherein the personal stack and the system stack are automatically created.

7. The method of claim 1, further comprising automatically synchronizing the stacks.

8. The method of claim 1, further comprising receiving a selection to create a stack that indicates electronic content to associate with the stack.

9. The method of claim 1, wherein displaying the stack comprises displaying new activities since a last view of the stack, a total number of activities, meeting events and a to-do list.

10. A computer-readable medium having computer-executable instructions for organizing electronic content, comprising:
determining when to create a stack that relates electronic content that comprise messages and documents across different applications;
tagging electronic content with a tag to associate with the stack;
receiving a request to interact with the stack;
accessing the stack that associates the electronic content using the tag; and
displaying a view of the stack that includes at least a portion of the electronic content that is associated with the stack.

11. The computer-readable medium of claim 10, wherein the electronic content comprises events, documents, and electronic messages.

12. The computer-readable medium of claim 10, wherein displaying the view of the stack comprises displaying a summary view of the electronic content within the stack.

13. The computer-readable medium of claim 10, wherein the different applications comprise an electronic messaging system and a content system.

14. The computer-readable medium of claim 10, further comprising synchronizing stacks across different applications.

15. The computer-readable medium of claim 10, further comprising receiving a selection of content that is used to determine initial electronic content for the stack.

16. The computer-readable medium of claim 10, wherein displaying the stack comprises displaying activities related to the stack, and current interactions with the stack.

17. A system for organizing electronic content, comprising:
a network connection that is coupled to tenants of the multi-tenant service;
a processor and a computer-readable medium;
an operating environment stored on the computer-readable medium and executing on the processor; and
a stack manager operating under the control of the operating environment and operative to actions comprising:
determining when to create a stack that relates electronic content that comprise messages and documents across different applications comprising a messaging system and a content system;
tagging electronic content with a tag to associate with the stack;
receiving a request to interact with the stack;
accessing the stack that associates the electronic content using the tag; and
displaying a view of the stack that includes at least a portion of the electronic content that is associated with the stack.

18. The system of claim 17, wherein displaying the view of the stack comprises displaying a summary view of the electronic content within the stack.

19. The system of claim 17, further comprising receiving a selection of content that is used to determine initial electronic content for the stack.

20. The system of claim 17, wherein displaying the stack comprises displaying activities related to the stack, and current interactions with the stack.
